(19) United States
(12) Patent Application Publication
(10) Pub. No.: US 2024/0188038 A1
(43) Pub. Date: Jun. 6, 2024

(54) SUPPORT FOR MOBILE TERMINATED SMALL DATA TRANSMISSION IN FIFTH GENERATION SYSTEMS

(71) Applicant: Intel Corporation, Santa Clara, CA (US)

(72) Inventors: Marta Martinez Tarradell, Portland, OR (US); Sudeep Palat, Cheltenham (GB); Jaemin Han, Santa Clara, CA (US)

(21) Appl. No.: 18/441,716

(22) Filed: Feb. 14, 2024

Related U.S. Application Data
(60) Provisional application No. 63/446,192, filed on Feb. 16, 2023.

(51) Int. Cl. H04W 68/02; H04W 76/27

(52) U.S. Cl. CPC H04W 68/02; H04W 76/27

(57) ABSTRACT

The present disclosure is generally related to wireless and cellular communication, communication system implementations, and in particular, to support for mobile terminated small data transmission (MT-SDT) in 5G systems (5GS). A UE initiates a radio resource control (RRC) resume procedure with a resume cause value of “mt-SDT” in an RRC resume request when a mobile terminated small data transmission (MT-SDT) indication for the UE is included in a received paging message and a set of conditions for initiating MT-SDT have been fulfilled. The UE initiates the RRC resume procedure with a resume cause value of “mt-Access” in the RRC resume request message when the set of conditions for initiating MT-SDT have not been fulfilled. Other embodiments may be described and/or claimed.

### CROSS REFERENCE TO RELATED APPLICATION

The present application claims priority to U.S. Provisional App. No. 63/466,192 filed Feb. 16, 2023 (“'192”), the contents of which is hereby incorporated by reference in its entirety.

### BACKGROUND

Third Generation Partnership Project (3GPP) Fifth Generation (5G) Release 17 introduced small data transmission (SDT). In 3GPP systems, an SDT refers to a data transmission where a user equipment (UE) is in an inactive state, and the procedures used by such UEs to communicate such data transmissions.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1A depicts a procedure for mobile terminated early data transmission (MT-EDT) for user plane cellular IoT (CIoT) evolved packet core (EPS) optimization; FIG. 1B depicts an example mobile terminated small data transmission (MT-SDT) procedure;

FIG. 2 depicts an example Venn diagram showing overlapping radio bearers (RBs) configured for MT-SDT and mobile originated small data transmission (MO-SDT);

FIGS. 3A and 3B depict example SDT resume procedures;

FIGS. 4A and 4B depict examples radio resource control (RRC) states and corresponding transitions;

FIG. 5 depicts an example procedure to determine a resume cause value to use when detecting MT-SDT indication for a given UE;

FIG. 6 depicts an example network architecture;

FIG. 7 depicts an example wireless network and example components of network nodes; and

FIG. 8 depicts example hardware resources.

### DETAILED DESCRIPTION

### 1. Mobile Terminated Small Data Transmission (MT-SDT) Aspects

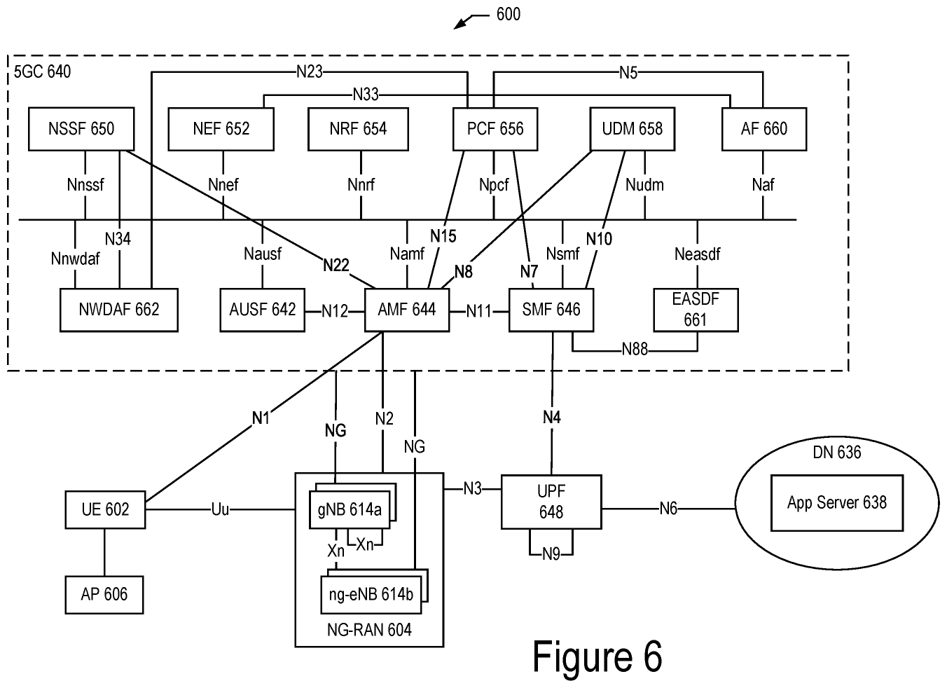

The present disclosure is generally related to wireless and cellular communication, communication system implementations, and in particular, to support for mobile terminated small data transmission (MT-SDT) in 5G systems (5GS). In 3GPP systems, MT-SDT refers to the process of sending a small amount of data from the network to a UE (e.g., UE 602 in FIG. 6). The term “mobile terminated” indicates that the data transmission is initiated from the network and terminated at the mobile device.

Many internet of things (IOT) devices, such as wireless sensors, low-power devices, small form factor devices, embedded devices, wearable devices, actuators, and/or the like, may communicate (e.g., transmit and/or receive) relatively small amounts of data per transmission. The normal procedures for a Third Generation Partnership Project (3GPP) fifth generation (5G) network in such cases would be to move the device from an inactive state to an active state via control signaling, transmit/receive the data in a data packet, and then move back to the inactive state using more control signaling. Since the transmission needs of IoT devices are usually periodic or relatively infrequent, the IoT devices would need to perform multiple transmission setup and release procedures to transfer relatively small amount of data each time.

As the payload data from an IoT device can be relatively small compared to the control signaling required to send it over the radio interface, establishing and releasing a connection for communicating small data can create significant overhead relative to the amount of data actually being sent. Because many IoT devices have limited battery capacity, this overhead can become a significant burden on these IoT devices since control signaling procedures can require significant power/energy consumption. The control signaling overhead can also become a burden on the network, such as when there are a large number of IoT devices deployed in a given environment.

In Release (Rel-)17, 3GPP introduced small data transmission (SDT) procedures in order to reduce the overhead burdens related to the transmission of small data. With SDT it is possible for a UE to send a small data payload while remaining in an inactive state (e.g., RRC_INACTIVE). SDT includes procedures for data and/or signaling transmission (referred to as “small data”) while the UE remains in the inactive state and without transitioning to a connected state (e.g., RRC_CONNECTED). SDT is enabled on a radio bearer basis and is initiated by the UE only if less than a configured amount of uplink (UL) data awaits transmission across all radio bearers for which SDT is enabled; otherwise, the normal data transmission scheme is used. With SDT, the small data is transmitted quickly on the allocated resource. The UE initiates the SDT procedure by transmitting an RRC request message and payload data in parallel, instead of the typical procedure where the data is transmitted after the RRC request message is processed by the network. Since the UE stays in the inactive state, it does not have to perform various tasks associated with the active state, which improves the battery life of the UE and reduces congestion over the radio interface.

In particular, Rel-17 specified mobile originated SDT (MO-SDT) to allow for uplink (UL) transmission of small data. For downlink (DL) transmission of small data, MT-SDT (e.g., DL-triggered small data) allows similar benefits as mentioned previous, such as reducing signaling overhead and UE power consumption by not transitioning to RRC_CONNECTED and reducing latency by allowing fast transmission of (small and infrequent) packets (e.g., for positioning and/or the like).

One ongoing Rel-18 work item (WI) is Mobile Terminated-Small Data Transmission (MT-SDT) for NR, 3GPP TSG RAN Mecting #94c, TDoc RP-213583 (6-17 Dec. 2021) (“RP-213583”). One objective for NR_MT_SDT is to define new mechanism(s) to support MT-SDT, which is sometimes also referred to as “paging-triggered SDT”. However, it is still unclear how a UE can identify the radio bearers (RBs) to be used for MT-SDT, which are the changes required to resume procedure for SDT and the new UE radio capabilities required. A goal is to make Rel-18 MT-SDT feasible considering previous Rel-17 SDT, which target MO-SDT.

The present disclosure provides mechanisms for UEs to identify MT-SDT RBs, changes required to resume procedure when MT-SDT is supported/configured to a given UE, and UE radio capabilities for MT-SDT. The embodiments discussed herein reduce UE power consumption, latency when responding to paging, and reduce the amount of signaling required to perform data exchange since the UE remains in an RRC_INACTIVE state. The various solutions discussed herein may be specified and/or defined in relevant 3GPP specifications, such as [TS38300], [TS38331], [TS38321], and/or the like.

### 1.1. Release-18 MT-SDT Aspects

3GPP Rel-18 MT-SDT is a feature aimed to be specified as explained in RP-213583, which includes the following objectives: specify the support for paging-triggered SDT (e.g., MT-SDT) [RAN2, RAN3], including: MT-SDT triggering mechanism for UEs in RRC_INACTIVE, supporting random access channel (RACH) and configured grant SDT (CG-SDT) based as the UL response; and MT-SDT procedure for initial DL data reception and subsequent UL/DL data transmissions in RRC_INACTIVE. RAN2 initial discussion concluded with the following agreements:

RBs: MT-SDT is data that belongs to bearers that are configured for SDT. The network can only trigger MT-SDT if the data belongs to those bearers configured for SDT. FFS whether the configuration is MO-SDT or MT-SDT specific.

Network (NW) indication: For RAN paging, MT-SDT indication (e.g., at least one bit) is explicitly included per UE via a paging message. It is for future study (FFS) if more information for MT-SDT is/are needed, what the indication will be called, and signaling details.

SDT configuration: It is possible for the NW to configure only MT-SDT without MO-SDT random access (RA) resources and/or CG-SDT. Subsequent UL/DL data belonging to SDT bearers while in INACTIVE is allowed like MO-SDT procedure.

UE access: a UE can use non-SDT RA resources for accessing the NW for an MT-SDT transfer. The UE can also use the configured grant resources and/or MO-RA resources.

UE indication: The NW should be able to differentiate why the UL access was triggered, for example, implicit or explicit indication by the UE. New resume cause (e.g., ResumeCause IE values) in RRC resume (e.g., RRCResumeRequest, RRCResumeRequest1, UEAssistanceInformation, and/or the like) will be introduced, one code point MT-SDT indication.

Subsequent operation: Rel-18 MT-SDT after the MT-SDT paging trigger is detected, RA-SDT and CG-SDT solutions/procedures specified in Rel-17 is/are re-used as a baseline. The detailed triggers will be discussed on case by case. FFS on resources used for access.

### 1.2. LTE Mobile Terminated Early Data Transmission (MT-EDT) Operation

The LTE feature of mobile terminated early data transmission (MT-EDT) is intended for a single DL data transmission during a random access procedure. MT-EDT is initiated by a mobility management entity (MME) if a UE and the network support MT-EDT and there is a single DL data transmission for the UE.

MT-EDT for control plane CIoT EPS optimization and for user plane CIoT EPS optimization, as defined in 3GPP TS 23.401, is characterized as follows: support for MT-EDT for the Control Plane CIoT EPS Optimisation and/or for the User Plane CIoT EPS Optimisation is reported by UE at NAS level; DL data size is included in the S1-AP Paging message for the UE; MT-EDT indication is included in the Paging message for the UE over the Uu interface; for User Plane CIoT EPS Optimisation, the UE has been provided with a NextHopChainingCount in the RRCConnectionRelease message with suspend indication; in response to the Paging message including MT-EDT indication, the UE triggers the MO-EDT procedure for Control Plane CIoT EPS Optimisation or for User Plane CIoT EPS Optimisation if the upper layers request the establishment or resumption of the RRC Connection for Mobile Terminated Call; and there is no transition to RRC CONNECTED. MT-EDT is only applicable to BL UEs, UEs in enhanced coverage and NB-IOT UEs.

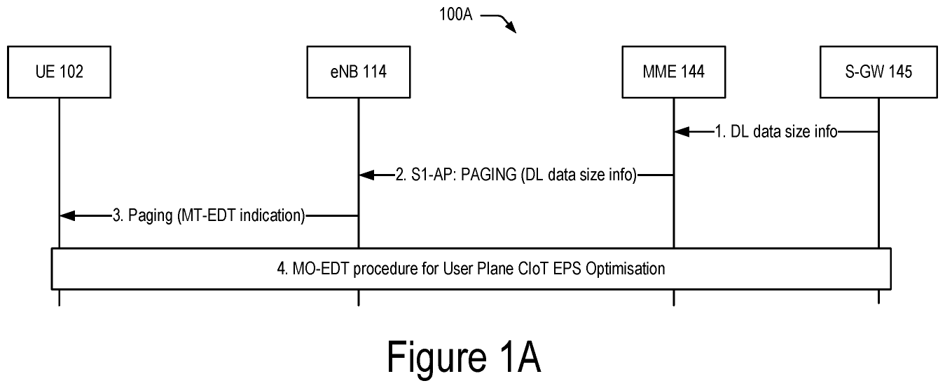

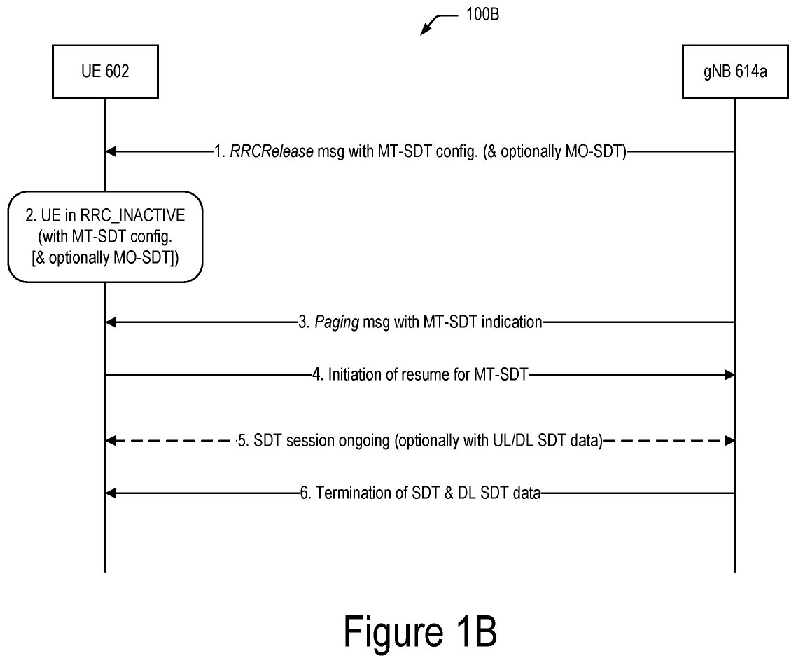

FIG. 1A depicts an example MT-EDT procedure 100A for user plane CIoT EPS optimization. The MT-EDT procedure 100A operates as follows.

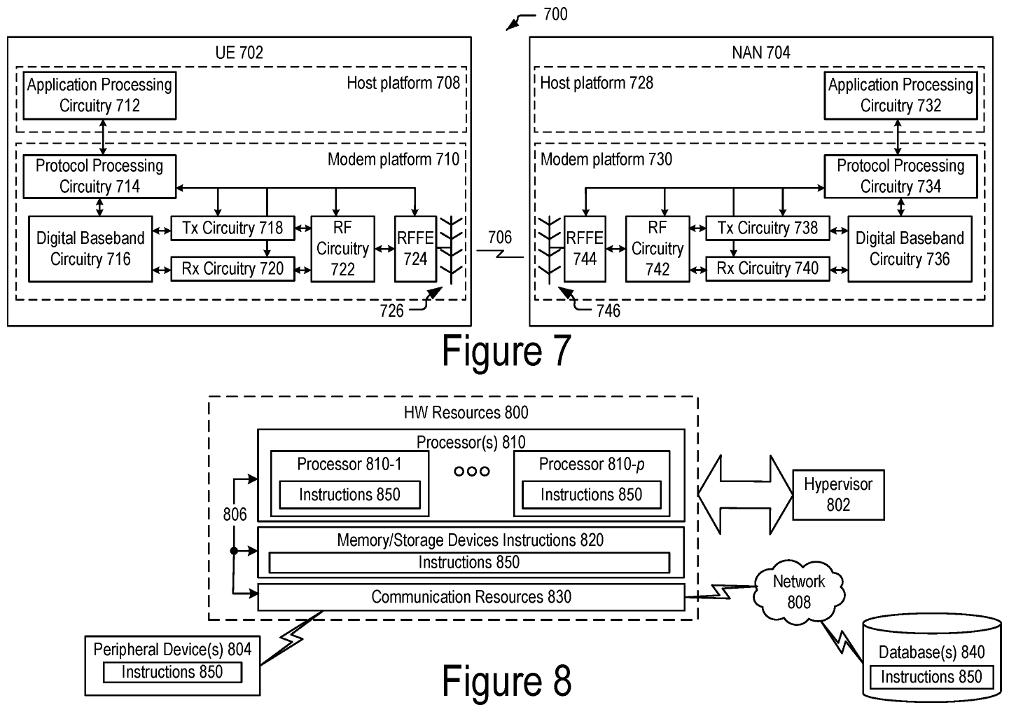

At operation 1, upon arrival of DL data, a serving gateway (S-GW) 145 sends DL data size information to a MME 144 for mobile terminated early MT-EDT consideration by the MME 144. At operation 2, the MME 144 includes the DL data size in the S1-AP PAGING message to assist eNB in triggering MT-EDT. At operation 3, if the data can fit in one single DL transmission according to the UE category included in the UE Radio Capability for Paging provided in the S1-AP Paging message, the eNB 114 includes mt-EDT indication in the Paging message for the UE 102. In some examples, the UE 102 may be the same or similar as the UE 602 of FIG. 6. At operation 4, the UE 102 initiates the MO-EDT procedure for the user plane CIOT EPS optimization as described in [TS36300] § 7.3b.3, FIG. 7.3b-2 with the following differences: in operation 0, the UE selects a random access preamble not configured for EDT; in operation 1, the UE sends RRCConnectionResumeRequest message with the resume cause mt-EDT and without user data; and in operation 4, the MME may include the Pending Data Indication in the S1AP UE Context Resume Response message to notify the eNB of further data traffic in excess of that initially signaled in operation 2. The eNB may use this indication to decide whether to release the UE.

The LTE feature of MT-EDT for User Plane CIOT EPS optimization targets similar requirements as Rel-18 MT-SDT in NR/5G. For MT-EDT for User Plane CIOT EPS optimization, when an evolved node b (eNB) determines that MT-EDT can be initiated, the eNB sends an mt-EDT indication to a UE in a specific paging record in the paging message. The eNB receives from an MME “DL data size information” as part of S1-AP PAGING message. If the data can fit in a single DL transmission, the eNB includes mt-EDT indication in the paging message for the UE. Note that the LTE EDT feature only supported transmission of one UL and one DL transmission, which is different than Rel-17 SDT and the new target Rel-18 SDT. The ASN.1 associated with this mt-EDT indication in Paging message is shown in Table 1.2-1 and captured in [TS38331].

TABLE 1.2-1

| Paging ::= | SEQUENCE { | |
|---|---|---|
| pagingRecordList | PagingRecordList | OPTIONAL, -- Need ON |
| systemInfoModification | ENUMERATED {true} | OPTIONAL, -- Need ON |
| etws-Indication | ENUMERATED {true} | OPTIONAL, -- Need ON |
| nonCriticalExtension | Paging-v890-IEs | OPTIONAL |

}
<*** TEXT OMITTED ***>

| Paging-v1530-IEs ::= | SEQUENCE { | |
|---|---|---|
| accessType | ENUMERATED {non3GPP} | OPTIONAL, -- Need ON |
| nonCriticalExtension | Paging-v1610-IEs | OPTIONAL |

}

| Paging-v1610-IEs ::= | SEQUENCE { | |
|---|---|---|
| pagingRecordList-v1610 | PagingRecordList-v1610 | OPTIONAL, -- Need ON |
| uac-ParaModification-r16 | ENUMERATED {true} | OPTIONAL, -- Need ON |
| nonCriticalExtension | Paging-v1700-IEs | OPTIONAL |

}

| PagingRecordList ::= | SEQUENCE (SIZE (1..maxPageRec)) OF PagingRecord | |
|---|---|---|
| PagingRecordList-v1610 ::= | SEQUENCE (SIZE (1..maxPageRec)) OF PagingRecord-v1610 | |
| PagingRecord-v1610 :: | SEQUENCE { | |
| accessType-r16 | ENUMERATED {non3GPP} | OPTIONAL, -- Need ON |
| mt-EDT-r16 | ENUMERATED {true} | OPTIONAL Need ON |

}

When the UE 102 detects MT-EDT data for the user plane CIOT EPS optimization, the UE 102 initiates resume with non-EDT RA preambles and including a mt-EDT resume cause value. The UE 102 selects an RA preamble not configured for EDT and sends RRCConnectionResumeRequest message with the resume cause mt-EDT and without user data (see e.g., Table 1.2-2).

TABLE 1.2-2

| | |
|---|---|
| RRConnectionResumeRequest-r13-IEs ::= | SEQUENCE { |
| resume Identity-r13 | CHOICE { |
| resumeID-r13 | ResumeIdentity-r13, |
| truncatedResumeID-r13 | BIT STRING (SIZE (24)) |

},

| | |
|---|---|
| shortResumeMAC-I-r13 | BIT STRING (SIZE (16)), |
| resumeCause-r13 | ResumeCause, |
| spare | BIT STRING (SIZE (1)) |

<*** TEXT OMITTED ***>

| | |
|---|---|
| ResumeCause ::= | ENUMERATED { |
| | emergency, highPriorityAccess, mt-Access, mo-Signalling, |
| | mo-Data, delayTolerantAccess-v1020, mo-VoiceCall-v1280, |
| | mt-EDT-V1610 |

}

The MME 144 could include the Pending Data Indication in the S1AP UE Context Resume Response message to notify the eNB of further data traffic in excess of that initially signalled. Based on that the eNB may use this indication to decide whether to release the UE 102.

### 1.3. MT-SDT Aspects

FIG. 1B shows an example MT-SDT procedure 100B of how an example MT-SDT mechanism is to operate. The MT-SDT procedure 100B operates as follows.

At operation 1, a gNB 614a sends an RRCRelease message (msg) with MT-SDT configuration to a UE 602. In some examples, the RRCRelease msg also includes an MO-SDT configuration. At operation 2, the UE 602 is in (or enters) an RRC_INACTIVE state/mode.

At operation 3, the gNB 614a sends a Paging msg with MT-SDT indication (mt-SDT) to the UE 602. At operation 4, the UE 602 sends an initiation of resume for MT-SDT to the gNB 614a. At operation 5, an SDT session is ongoing, optionally with UL and/or DL SDT data (e.g., small data) being communicated between the UE 602 and gNB 614a. At operation 6, the gNB 614a signals the UE 602 to terminate the SDT session and (with) DL SDT data (small data).

### 1.4. Enhanced MT-SDT Aspects

The present disclosure provides the following embodiments: mechanisms for a UE 602 to identify radio bearers (RBs) used for MT-SDT; changes required to resume procedure (e.g., RRC resume procedure) when MT-SDT is supported/configured to a given UE 602; and UE radio capabilities for MT-SDT. The mechanism(s) described herein may be enabled by itself or in conjunction with each other.

### 1.4.1. Mechanisms for UE to Identify Radio Bearers (RBS) Used for MT-SDT

RAN2 agreed that the MT-SDT feature should be able to be used/configured independently to MO-SDT (e.g., RA-SDT and/or CG-SDT). However, there may be cases where both MT-SDT and MO-SDT features may be configured at the same time. In various embodiments, a UE 602 can identify the RBs to be used for MT-SDT considering that MT-SDT may be configured by itself or in conjunction with, in relation to, or otherwise at a same or similar time as MO-SDT. It should also be noted that, for any of the examples discussed herein, the RBs to be used for MT-SDT can include data radio bearers (DRBs) and/or signaling radio bearers (SRBs).

Additionally or alternatively, the UE 602 and network are synchronized (synced) on which RBs need to be resumed to perform SDT in RRC_INACTIVE after detecting the MT-SDT indication provided to that UE 602. Different approaches and/or implementations can be defined as described in the present disclosure.

### 1.4.1.1. Explicit MT-SDT RB Configuration

In a first approach, a new configuration indicating the RB(s) applicable to MT-SDT is provided to the UE 602. In some examples, the MT-SDT RB configuration is provided via a SuspendConfig information element (IE) in an RRCRelease message (see e.g., table 1.4-1). Additionally or alternatively, a separate indication is included to indicate whether a packet data convergence protocol (PDCP) entity of the radio bearers configured for SDT continues or resets the robust header compression (ROHC) protocol during PDCP re-establishment during SDT procedure (see e.g., table 1.4-2). Other IEs and/or RRC messages can be used to convey the MT-SDT RB configuration in other implementations.

TABLE 1.4-1

| SuspendConfig : : = | SEQUENCE { | |
|---|---|---|
| fullI-RNTI | I-RNTI-Value, | |
| shortI-RNTI | ShortI-RNTI-Value, | |
| ran-PagingCycle | PagingCycle, | |
| ran-NotificationAreaInfo | RAN-NotificationAreaInfo | OPTIONAL, -- Need M |
| t380 | PeriodicRNAU-TimerValue | OPTIONAL, -- Need R |

| | |
|---|---|
| nextHopChainingCount | NextHopChainingCount, |

```
    ...,
    [[
```

| | | |
|---|---|---|
| sl-UEIdentityRemote-r17 | RNTI-Value | OPTIONAL, -- Cond L2RemoteUE |

| | |
|---|---|
| sdt-Config-r17 | SetupRelease { SDT-Config-r17 } OPTIONAL, -- Need M |

srs-PosRRC-Inactive-r17 SetupRelease { SRS-PosRRC-Inactive-r17 } OPTIONAL, -- Need M

| | |
|---|---|
| ran-ExtendedPagingCycle-r17 | ExtendedPagingCycle-r17 OPTIONAL -- Cond RANPaging |

```
  ]],
  [[
  mt-SDT-Config-rXY SetupRelease { MT-SDT-Config-rXY } OPTIONAL -- Need M
  ]]
}
```

TABLE 1.4-2

| | |
|---|---|
| MT-SDT-Config-rXY ::= | SEQUENCE { |

mt-SDT-DRB-List-rXY SEQUENCE (SIZE (0..maxDRB)) OF DRB-Identity OPTIONAL, -- Need R

| | | |
|---|---|---|
| mt-SDT-SRB2-Indication-rXY | ENUMERATED { allowed} | OPTIONAL, -- Need R |
| mt-SDT-DRB-ContinueROHC-rXY | ENUMERATED { cell, rna } | OPTIONAL, -- Need R |
| } | | |

Additionally or alternatively, some or all of the indicated MT-SDT RBs may be configured for MO-SDT. In some examples, the MT-SDT RBs (or a subset of the MT-SDT RBs) are a subset of the configured MO-SDT RBs. This could be indicated, for example, by adding a rule or expected behavior in the description corresponding field and/or a new condition that can be created for SDT.

Additional or alternative indication(s) may be provided to indicate whether initial access for MT-SDT can be performed via MO-SDT resources (e.g., RA-SDT and/or CG-SDT) assuming that they are configured and valid. An example of such indication(s) that RB(s) configured for SDT and/or the configurations provided for CG-SDT are also applicable/used for MT-SDT is shown by table 1.4-3.

TABLE 1.4-3

| MT-SDT-Config-rXY ::= | SEQUENCE { | |
|---|---|---|
| ra-SDT-rXY | ENUMERATED { allowed} | OPTIONAL, |
| cg-SDT- rXY | ENUMERATED { allowed} | OPTIONAL |

}

### 1.4.1.2. MO-SDT RB Configuration Indicating MT-SDT RB(S)

A second approach involves the RB(s) configured for MO-SDT (e.g., RA-SDT and/or CG-SDT), or a subset of configured MO-SDT RB(s), is/are used or extended for a UE 602 to identify the RB(s) applicable to MT-SDT.

1.4.1.2.1. Implicit Indication of MO-SDT RB(s) and/or MD-SDT RB(s)

In some implementations, the RB(s) configured for MO-SDT are indicated implicitly without any signaling. This would mean that specification defines/assumes that any RB configured for RA-SDT and/or CG-SDT is also applicable to use MT-SDT when UE 602 and network both support MT-SDT feature and UE 602 is configured with MT-SDT. This approach 2. A would not require any explicit new RRC signaling for configuration of MT-SDT RBs apart from a new UE radio capability for network to know that this UE 602 supports it (which is a topic discussed in previous section). UE 602 would also know if network supports MT-SDT or not as it is the network who initiated (if supported) paging including MT-SDT indication, e.g., this would be an implicit way for UE 602 to know that it can initiate resume (e.g., RRC resume procedure) due to MT-SDT indication.

1.4.1.2.2. Explicit Indication of MO-SDT RB(s) applicable to MD-SDT

Additionally or alternatively, the RB(s) configured for MO-SDT are indicated using explicit signaling, and the explicit signaling is used to indicate the (sub)set of MO-SDT RBs that are also applicable for MT-SDT. Table 1.4-4 shows an example configuration including an indication that MD-SDT is also configured, and table 1.4-5 shows an example configuration including an indication of the RB(s) configured for SDT (e.g., RA-SDT and/or CG-SDT) that are also applicable to (e.g., can be used for) MT-SDT, and table 1.4-6 shows an example configuration including an indication of the specific RB(s) configured for MO-SDT that are also applicable to (e.g., can be used for) MT-SDT.

TABLE 1.4-4

| SuspendConfig ::= | SEQUENCE { | |
|---|---|---|
| fullI-RNTI | I-RNTI-Value, | |
| shortI-RNTI | ShortI-RNTI-Value, | |
| ran-PagingCycle | PagingCycle, | |
| ran-NotificationAreaInfo | RAN-NotificationAreaInfo | OPTIONAL, -- Need M |
| t380 | PeriodicRNAU-TimerValue | OPTIONAL, -- Need R |

| | |
|---|---|
| nextHopChainingCount | NextHopChainingCount, |

```
  ...,
  [[
```

| sl-UEIdentityRemote-r17 | RNTI-Value | OPTIONAL, -- Cond L2RemoteUE |
|---|---|---|
| sdt-Config-r17 | SetupRelease { SDT-Config-r17} | OPTIONAL, -- Need M |
| srs-PosRRC-Inactive-r17 | SetupRelease { SRS-PosRRC-Inactive-r17} OPTIONAL, -- Need M | |
| ran-ExtendedPagingCycle-r17 | ExtendedPagingCycle-r17 | OPTIONAL -- Cond RANPaging |

```
  ]],
  [[
```

| | | |
|---|---|---|
| mt -SDT-rXY | ENUMERATED { allowed} | OPTIONAL |

]]
}

TABLE 1.4-5

| SuspendConfig : : = | SEQUENCE { | |
|---|---|---|
| fullI-RNTI | I-RNTI-Value, | |
| shortI-RNTI | ShortI-RNTI -Value, | |
| ran-PagingCycle | PagingCycle, | |
| ran-NotificationAreaInfo | RAN-NotificationAreaInfo | OPTIONAL, -- Need M |
| t380 | PeriodicRNAU-TimerValue | OPTIONAL, -- Need R |
| nextHopChainingCount | NextHopChainingCount, | |

```
  ...,
  [[
```

| | | |
|---|---|---|
| sl-UEIdentityRemote-r17 | RNTI-Value | OPTIONAL, -- Cond L2RemoteUE |
| sdt-Config-r17 | SetupRelease {SDT-Config-r17} | OPTIONAL, -- Need M |

| | |
|---|---|
| srs-PosRRC-Inactive-r17 | SetupRelease {SRS-PosRRC-Inactive-r17} OPTIONAL, -- Need M |

| | |
|---|---|
| ran-ExtendedPagingCycle-r17 ExtendedPagingCycle-r17 | OPTIONAL -- Cond RANPaging |

```
  ]],
  [[
```

| | | |
|---|---|---|
| ra-SDT-RB-rXY | ENUMERATED {allowed} | OPTIONAL, |
| cg-SDT-rXY | ENUMERATED {allowed} | OPTIONAL, |

]]
}

TABLE 1.4-6

| SuspendConfig ::= | SEQUENCE { | |
|---|---|---|
| fullI-RNTI | I-RNTI -Value, | |
| shortI-RNTI | ShortI-RNTI-Value, | |
| ran-PagingCycle | PagingCycle, | |
| ran-NotificationAreaInfo | RAN-NotificationAreaInfo | OPTIONAL, -- Need M |
| t380 | PeriodicRNAU-TimerValue | OPTIONAL, -- Need R |

| | |
|---|---|
| nextHopChainingCount | NextHopChainingCount, |

```
  ...,
  [[
```

| | | |
|---|---|---|
| sl-UEIdentityRemote-r17 | RNTI-Value | OPTIONAL, -- Cond L2RemoteUE |

| | |
|---|---|
| sdt-Config-r17 | SetupRelease { SDT-Config-r17} OPTIONAL, -- Need M |
| srs-PosRRC-Inactive-r17 | SetupRelease { SRS-PosRRC-Inactive-r17} OPTIONAL, -- Need M |

| | |
|---|---|
| ran-ExtendedPagingCycle-r17 ExtendedPagingCycle-r17 | OPTIONAL -- Cond RANPaging |

```
  ]],
  [[
```

| sdt-DRB-List-rXY | SEQUENCE (SIZE (0..maxDRB)) OF DRB-Identity OPTIONAL, | |
|---|---|---|
| sdt-SRB2-Indication-rXY | ENUMERATED {allowed} | OPTIONAL |

]]
}

In the example of table 1.4-6, the sdt-DRB-List-rXY IE/parameter only includes DRBs that are configured for MT-SDT, and the sdt-SRB2-Indication-rXY IE/parameter indicates when signaling radio bearer 2 (SRB2) is allowed for MT-SDT.

### 1.4.1.2.3. Explicit Indication of MO-SDT RB(s) not Applicable to MD-SDT

In some implementation, explicit signaling is used to indicate the MO-SDT RBs that are not applicable for MT-SDT. As examples, this indication can be embodied as a list of forbidden or prohibited MO-SDT-RB(s) (e.g., a (seb)set of RBs configured for RA-SDT and/or CG-SDT) that cannot be used to trigger MT-SDT.

Additionally or alternatively, the NW may want to indicate whether an RA-SDT and/or CG-SDT configuration can or cannot be used for MT-SDT. This can be done by indicating which configuration is applicable or not to be used for MT-SDT, as shown by the example of table 1.4-7.

TABLE 1.4-7

| SuspendConfig ::= | SEQUENCE { | |
|---|---|---|
| fullI-RNTI | I-RNTI-Value, | |
| shortI-RNTI | ShortI-RNTI-Value, | |
| ran-PagingCycle | PagingCycle, | |
| ran-NotificationAreaInfo | RAN-NotificationAreaInfo | OPTIONAL, -- Need M |
| t380 | PeriodicRNAU-TimerValue | OPTIONAL, -- Need R |

| | |
|---|---|
| nextHopChainingCount | NextHopChainingCount, |

```
  ...,
  [[
```

| | | |
|---|---|---|
| sl-UEIdentityRemote-r17 | RNTI-Value | OPTIONAL, -- Cond L2RemoteUE |
| sdt-Config-r17 | SetupRelease {SDT-Config-r17} | OPTIONAL, -- Need M |

| | |
|---|---|
| srs-PosRRC-Inactive-r17 | SetupRelease {SRS-PosRRC-Inactive-r17} OPTIONAL, -- Need M |

| | |
|---|---|
| ran-ExtendedPagingCycle-r17 ExtendedPagingCycle-r17 | OPTIONAL -- Cond RANPaging |

```
  ]],
  [[
  cg-SDT-ConfigLCH-rXY SEQUENCE(SIZE(1..maxLC-ID)) OF LogicalChannelIdentity OPTIONAL
  ]]
}
```

Moreover, it may be possible that any of the new signaling/indications discussed herein is defined to allow delta signaling by using Setup/Release. For example, a new MT-SDT specific IE can be defined containing the RB configured for SDT and/or logical channel (LCH) configured for CG-SDT that are also applicable/used for MT-SDT (see e.g., table 1.4-8).

TABLE 1.4-8

| | |
|---|---|
| mt-SDT-Config-rXY | SetupRelease { MT-SDT-Config-rXY } OPTIONAL -- Need M |

...

| | |
|---|---|
| MT-SDT-Config-rXY ::= | SEQUENCE { |
| sdt-DRB-List-rXY | SEQUENCE (SIZE (0..maxDRB)) OF DRB-Identity OPTIONAL, |
| sdt-SRB2-Indication-rXY | ENUMERATED { allowed} OPTIONAL, |
| cg-SDT-ConfigLCH-rXY | SEQUENCE (SIZE(1..maxLC-ID)) OF LogicalChannelIdentity OPTIONAL |

}

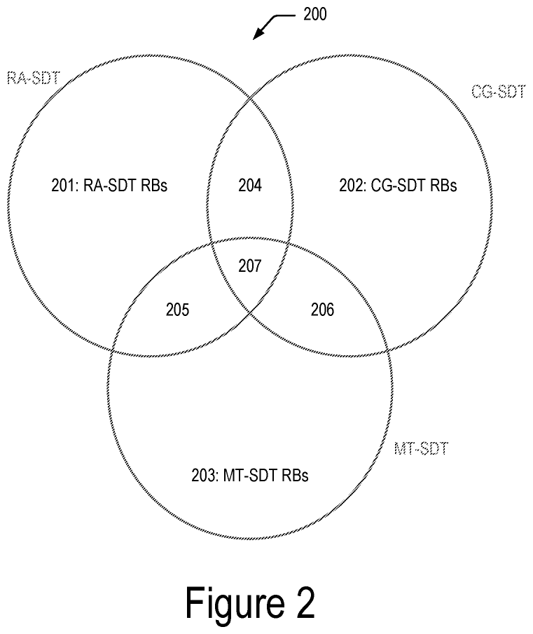

Therefore, the RB(s) and/or RB configurations used for MT-SDT (e.g., MT-SDT RBs) can be the same, different, or partially overlapping to the RBs configured for MO-SDT (e.g., including RA-SDT and/or CG-SDT) as shown by Venn diagram 200 of FIG. 2. For this, it is also possible to enable both signaling approaches explained previously to allow reusing MO-SDT configuration(s) (see e.g., section 1.4.1.2) and/or MT-SDT specific configuration(s) (see e.g., section 1.4.1.1).

In the example of FIG. 2, circle 201 represents a (sub)set of RBs that can be used for RA-SDT (e.g., RA SDT RBs), circle 202 represents a (sub)set of RBs that can be used for CG-SDT (e.g., CG-SDT RBs), and circle 203 represents a (sub)set of RBs that can be used for MT-SDT (e.g., MT-SDT RBs). Section 204 represents an overlapping region (or intersection) between circles 201 and 202, and includes a (sub)set of RBs that can be used for RA-SDT and/or CG-SDT (e.g., RA-SDT & CG-SDT RBs). Section 205 represents an overlapping region (or intersection) between circles 201 and 203, and includes a (sub)set of RBs that can be used for RA-SDT and/or MT-SDT (e.g., RA-SDT & MT-SDT RBs). Section 206 represents an overlapping region (or intersection) between circles 202 and 203, and includes a (sub)set of RBs that can be used for MT-SDT and/or RA-SDT (e.g., MT-SDT & RA-SDT RBs). Section 207 represents an overlapping region (or intersection) between circles, 201, 202, and 203, and includes a (sub)set of RBs that can be used for RA-SDT, CG-SDT, and/or MT-SDT (e.g., RA-SDT & CG-SDT & MT-SDT RBs).

### 1.4.2. Impacts to Resume Procedure Initiation Considering Mt-Sdt

As explained previously, a UE 602 and NW (e.g., RAN 604 and/or RAN node 614) need to be aligned on which RBs are resumed when initiating resume and when MT-SDT is supported and/or configured. In addition, at least some RBs configured for SDT can be the same, different, or partially overlapping between MT-SDT and MO-SDT. Considering all of this, the following approaches are possible on how to update resume procedure when initiating it for MT-SDT.

1.4.2.1. Any RB(s) Configured for Sdt is/are Resumed when Initiating Sdt

In some implementations, any RB(s) configured for SDT is/are resumed when initiating SDT, including both MT-SDT and MO-SDT. This approach allows any SDT data (e.g., data belonging to any RB configured for SDT) to be exchanged during an SDT procedure initiated duc to an MT-SDT indication. In these implementations, all RBs configured for SDT (e.g., MO-SDT and/or MT-SDT) are resumed when initiating the resume due to an MT-SDT indication.

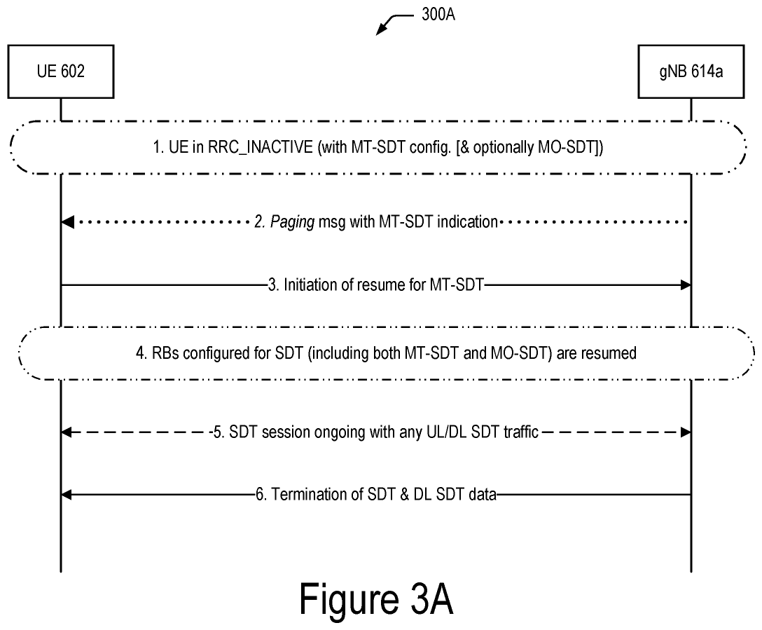

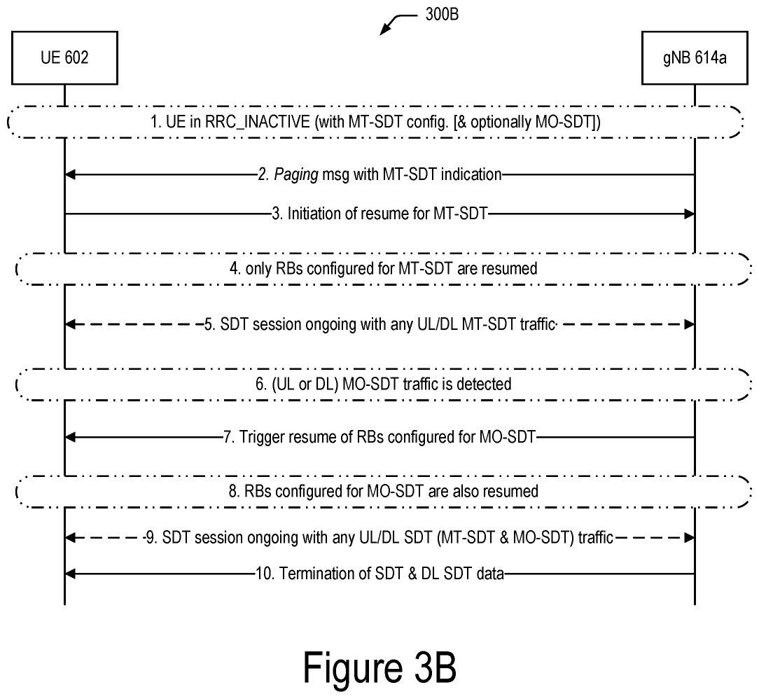

FIG. 3A depicts an example procedure 300A, which shows an SDT mechanism for this approach when configured with MT-SDT and MO-SDT. Procedure 300A operates as follows: At operation 1, the UE 602 is in the RRC_INACTIVE state with MT-SDT configured and optionally MO-SDT configured. At operation 2, the gNB 614a transmits a Paging msg with an MT-SDT indication to the UE 602. At operation 3, the UE 602 sends a msg indicating the initiation of resume for MT-SDT. At operation 4, the RB(s) configured for SDT, including both MT-SDT and MO-SDT, are resumed. At operation 5, the SDT session is ongoing with any UL/DL SDT traffic being conveyed between the UE 602 and gNB 614a. At operation 6, the gNB 614a sends a message to indicate termination of SDT and DL SDT data to the UE 602.

[TS38331] was updated in Rel-17 to incorporate the functionality associated to MO-SDT. In some examples, the handling of the RBs described in [TS38331] § 5.3.13.3 (“Actions related to transmission of RRCResumeRequest or RRCResumeRequest1 message”) can be reused for this approach as it refers in general to RBs configured for SDT as is shown by the example of table 1.4-9.

```
TABLE 1.4-9
5.3.13.3 Actions related to transmission of RRCResumeRequest or RRCResumeRequest1
message
The UE shall set the contents of RRCResumeRequest or RRCResumeRequest1 message as
follows:
  [...]
  1> re-establish PDCP entities for SRB1;
  1> resume SRB1;
  1> if the resume procedure is initiated for SDT:
  2> for each radio bearer that is configured for SDT and for SRB1:
      3> restore the RLC-BearerConfig associated with the RLC bearers of
        masterCellGroup and pdcp-Config from the UE Inactive AS context;
    3> if the radio bearer is a DRB configured with Ethernet Header Compression:
        4> indicate to lower layer that ethernetHeaderCompression is not configured;
      3> if the radio bearer is a DRB configured with UDC:
        4> indicate to lower layer that uplinkDataCompression is not configured;
      3> if the radio bearer is a DRB configured with ROHC function:
        4> if sdt-DRB-ContinueROHC is set to cell and the resume procedure is
          initiated in a cell that is the same as the PCell in which the UE received
          the previous RRCRelease message; or
        4> if sdt-DRB-ContinueROHC is set to rna and the resume procedure is initiated
          in a cell belonging to the same RNA as the PCell in which the UE received
          the previous RRCRelease message :
          5> indicate to lower layer that drb-continueROHC is configured;
        4> else:
          5> indicate to lower layer that drb-continueROHC is not configured;
      3> re-establish PDCP entity for the radio bearer that is configured for SDT
        without triggering PDCP status report;
    2> resume all the radio bearers that are configured for SDT;
  [...]
```

According to this approach, when the UE 602 initiates resume for MO-SDT or resume for MT-SDT, the UE 602 enters an SDT state (e.g., where an SDT session is ongoing) and all RBs configured for SDT (including both MO-SDT and MT-SDT) are resumed.

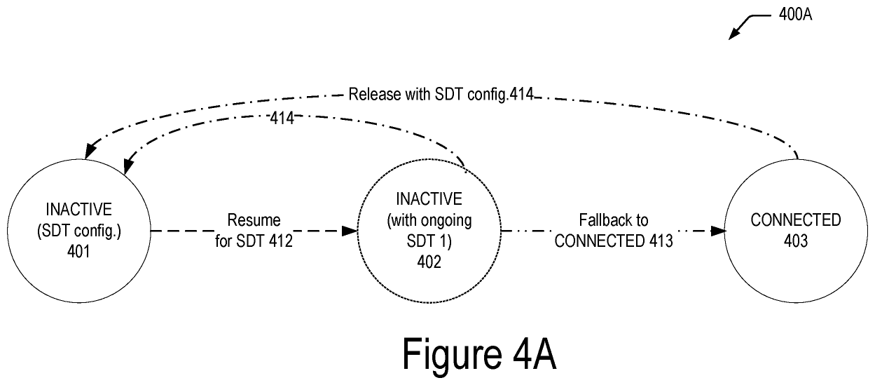

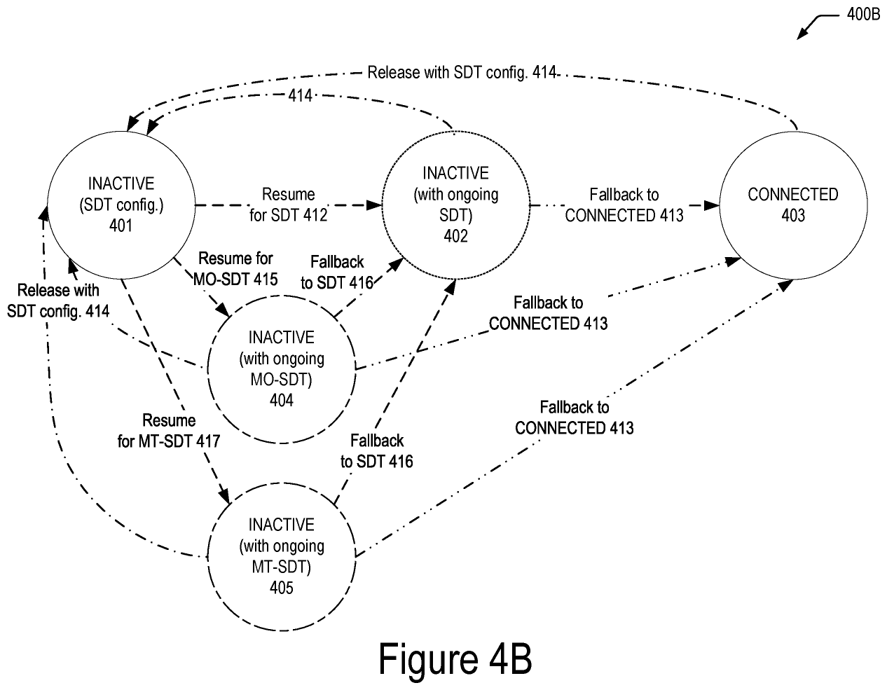

FIG. 4A depicts an example finite state machine (FSM) 400A showing the RRC states and corresponding transitions for the approach where all SDT RB(s) are resumed for any SDT session (independent of the trigger to resume (MO-SDT or MT-SDT)). In the example of FIG. 4A, the UE 602 in the inactive state 401 with SDT configured transitions to the inactive state 402 with an ongoing SDT session 402 based on a resume for SDT 412 being triggered. The SDT session can include traffic belonging to RBs configured for MT-SDT and/or MO-SDT (e.g., RA-SDT and/or CG-SDT) being conveyed/communicated. The UE 602 in the inactive state 402 can transition back to the inactive state 401 based on a release indication 414 (with an SDT configuration). The UE 602 in the connected state 403 can transition back to the inactive state 401 based on a release indication 414 (with an SDT configuration). The UE 602 in the inactive state 402 can transition to a connected state 403 when a connected mode fallback mechanism 413 is triggered or otherwise activated. The fallback mechanism 413 can include any of those discussed herein and/or any mechanism that causes the UE 602 to enter the connected state (e.g., RRC_CONNECTED mode). The inactive states 401 and 402 may be an RRC_INACTIVE state, and the connected state 403 may be an RRC_CONNECTED state.

### 1.4.2.2. Only Applicable RBS are Resumed

In some implementations, only the relevant and/or applicable RBs used for SDT are resumed. For example, when initiating SDT due to MT-SDT, the (sub)set of RBs configured for MT-SDT are initially only resumed, or when initiating SDT due to MO-SDT, the (sub)set of RBs configured for MO-SDT are initially only resumed. This approach involves on only resuming the RBs specific to a specific kind of access (e.g., MO-SDT and/or MT-SDT). Here, the SDT session would only allow the exchange of data belonging to those MT-SDT RBs or MO-SDT RBs. If this approach were adopted the text in [TS38331] § 5.3.13.3 (sec e.g., table 1.4-9, supra) may be updated to differentiate the resume for MO-SDT vs MT-SDT. Additionally, the way in which to handle the scenarios when an SDT session is ongoing for MO-SDT or MT-SDT and new data comes for the other kind of SDT may need to be further specified or defined.

According to this approach, when the UE 602 initiates resume for MO-SDT, the UE 602 enters an MO-SDT state (e.g., where an MO-SDT session is ongoing) and only RBs configured for MO-SDT are resumed. Similarly, when the UE 602 initiates resume for MT-SDT, the UE 602 enters an MT-SDT state (e.g., where an MT-SDT session is ongoing) and only RBs configured for MT-SDT are resumed. Here, new transitions from the MO-SDT state (or the MT-SDT state) to a combined MO-SDT and MT-SDT state may need to be defined. For example, the following options may be implemented to handle scenarios where an MT-SDT session is ongoing and new MO-SDT data is available and/or where an MO-SDT session is ongoing and new MT-SDT data is available.

In a first option, a new fallback mechanism is defined to resume the remaining SDT bearers only. This option can be used for the following scenarios: a first scenario involving a fallback from MT-SDT to (MT-SDT+MO-SDT), and a second scenario involving a fallback from MO-SDT to (MT-SDT+MO-SDT). For the fallback of the first scenario, the additional MO-SDT specific RBs would be resumed, and the UE 602 would still perform SDT (e.g., non-SDT data could not be performed and SDT related functionality would still apply). For this fallback of the second scenario, the additional MT-SDT specific RBs would be resumed, and the UE 602 would still perform SDT (e.g., non-SDT data could not be performed and SDT related functionality would still apply).

FIG. 3B depicts an example procedure 300B, which shows an SDT mechanism for the second approach with the first fallback option (first scenario) when configured with MT-SDT and MO-SDT. Procedure 300B operates as follows: At operation 1, the UE 602 is in the RRC_INACTIVE state with MT-SDT configured and optionally MO-SDT configured. At operation 2, the gNB 614a transmits a Paging msg with an MT-SDT indication to the UE 602. At operation 3, the UE 602 sends a msg indicating the initiation of resume for MT-SDT. At operation 4, only the RBs configured for MT-SDT are resumed. At operation 5, the SDT session is ongoing with any UL/DL MT-SDT traffic being conveyed between the UE 602 and gNB 614a. At operation 6, (UL or DL) MO-SDT traffic is detected by either the UE 602 and/or the gNB 614a. At operation 7, the gNB 614a sends a message to the UE 602 to trigger resume for the RBs configured for MO-SDT. At operation 8, the RBs configured for MO-SDT are also resumed. At operation 9, the SDT session is ongoing with any UL/DL SDT (MT-SDT and MO-SDT) traffic conveyed between the UE 602 and gNB 614a. At operation 10, the gNB 614a sends a message to indicate termination of SDT and DL SDT data to the UE 602

The first option includes signaling for the UE 602 and the NW to resume the additional applicable RBs. This signaling can include using existing messages (e.g., a suitable RRC message, such as RRCResume msg, Paging msg, or some other message discussed in [TS38331]), an extension/usage of existing RRC message (e.g., additional or new IEs/fields in an RRCResume msg, Paging msg, or some other message discussed in [TS38331]), and/or using a new DL dedicated message (e.g., an RRCResumeRB msg).

Additionally or alternatively, the new fallback mechanism for the first option can include new SDT indication (e.g., SDT-DataIndication) included in a suitable RRC msg (e.g., UEAssistanceInformation msg and/or some other message discussed in [TS38331]) for the UE 602 to indicate the NW when SDT data is in the UE's 602 buffers of SDT RBs that are still suspended.

In a second option includes using a legacy fallback mechanism to resume (e.g., UE 602 gets in a CONNECTED state, such as RRC_CONNECTED). This option would allow the UE 602 to only exchange SDT traffic in a subset of RBs from among a set of RBs configured for SDT. For example, assuming that certain RBs are configured for MT-SDT, the UE 602 can resume upon reception of an MT-SDT indication for all of the RBs configured for MT-SDT. After the resume takes place or is initiated, any subsequent UL/DL SDT (small data) could be exchanged while the SDT session if ongoing. However, if UL SDT data belonging to other RBs that are still suspended is detected (e.g., data belong to MO-SDT RBs that were not configured for MT-SDT), the NW (e.g., RAN node 614) can trigger a fallback to RRC_CONNECTED instead of allowing to resume afterwards the remaining MO-SDT RBs (e.g., during the ongoing SDT).

FIG. 4B depicts an example FSM 400B showing the RRC states and corresponding transitions for the approach where only MO-SDT or MT-SDT RB(s) are resumed (depending on the trigger to resume (for MO-SDT or MT-SDT)). FSB 400B includes states 401, 402, and 403 as described previously w.r.t FSM 400A of FIG. 4A.

In addition to the states and transitions described w.r.t FIG. 4A, in this example the UE 602 can transition from the inactive state 401 to an inactive state 404 with an ongoing MO-SDT session based on a resume for MO-SDT 415 being triggered. In the inactive state 404, only the MO-SDT session is ongoing where only traffic belonging to RBs configured for MO-SDT can be exchanged. The UE 602 in the inactive state 404 can transition to the inactive state 402 when an SDT fallback mechanism 416 is triggered or otherwise activated. The UE 602 in the inactive state 404 can also transition to the connected state 403 when the connected mode fallback mechanism 413 is triggered or otherwise activated. The UE 602 in the inactive state 404 can transition back to the inactive state 401 based on a release indication 414 (with an SDT configuration).

Furthermore, the UE 602 in the inactive state 401 can transition to an inactive state 405 with an ongoing MT-SDT session based on a resume for MT-SDT 417 being triggered. In the inactive state 405, only the MT-SDT session is ongoing where only traffic belonging to RBs configured for MT-SDT can be exchanged. The UE 602 in the inactive state 405 can transition to the inactive state 402 when an SDT fallback mechanism 416 is triggered or otherwise activated. The UE 602 in the inactive state 405 can also transition to the connected state 403 when the connected mode fallback mechanism 413 is triggered or otherwise activated. The UE 602 in the inactive state 405 can transition back to the inactive state 401 based on a release indication 414 (with an SDT configuration).

The fallback to SDT mechanism 416 allows resumption of the remaining SDT RBs while keeping the UE 602 in an inactive state (e.g., RRC_INACTIVE). This fallback mechanism 416 includes falling back from the MO-SDT session/state (404) to the SDT session/state (402) and falling back from an MT-SDT session/state (405) to the SDT session/state (402) as mentioned previously. The fallback mechanism 416 can include any of those discussed herein and/or any mechanism that causes the UE 602 to enter the an SDT session/state (e.g., state 402).

The approaches described in sections 1.4.2.1 and 1.4.2.2 have different states, different configurations used during different SDT sessions, and corresponding state transitions, as shown by FIGS. 4A and 4B. It should be noted that the approach of FIG. 4B introduces additional complexity due to the new temporal states, different kinds of sessions, and additional fallback transitions/mechanisms.

### 1.4.2.3. Conditions to Initiate SDT Considering MT-SDT

Legacy Rel-17 SDT defines conditions for initiating SDT in [TS38331] § 5.3.13.1b (as shown by table 1.4-10) and [TS38321] § 5.27 (as shown by Table 1.4-11).

```
TABLE 1.4-10
5.3.13.1b Conditions for initiating SDT
A UE in RRC INACTIVE initiates the resume procedure for SDT when all of the following
conditions are fulfilled:
  1> the upper layers request resumption of RRC connection; and
  1> SIB1 includes sdt-ConfigCommon; and
  1> sdt-Config is configured; and
  1> all the pending data in UL is mapped to the radio bearers configured for SDT; and
  1> lower layers indicate that conditions for initiating SDT as specified in
  [TS38321] are fulfilled.
  NOTE: How the UE determines that all pending data in UL is mapped to radio bearers
  configured for SDT is left to UE implementation.
```

TABLE 1.4-11
5.27 Small Data Transmission
5.27.1 General
The MAC entity may be configured by RRC with SDT and the SDT procedure may be
initiated by RRC layer. The SDT procedure can be performed either by Random Access
procedure with 2-step RA type or 4-step RA type (i.e., RA-SDT) or by configured grant
Type 1 (i.e., CG-SDT) .
RRC configures the following parameters for SDT procedure:

| | |
|---|---|
| - | sdt-DataVolumeThreshold: data volume threshold for the UE to determine whether to |
| | perform SDT procedure; |
| - | sdt-RSRP-Threshold: RSRP threshold for UE to determine whether to perform SDT |
| | procedure; |
| - | cg-SDT-RSRP-ThresholdSSB: an RSRP threshold configured for SSB selection for CG- |
| | SDT. |

The MAC entity shall, if initiated by the upper layers for SDT procedure:

```
1> if the data volume of the pending UL data across all RBs configured for SDT is
less than or equal to sdt-Data VolumeThreshold; and
NOTE: For SDT procedure, the MAC entity also considers the suspended RBs configured
with SDT for data volume calculation. It is up to the UE's implementation how the
UE calculates the data volume for the suspended RBs. Size of the CCCH message is
not considered for data volume calculation
1> if the RSRP of the downlink pathloss reference is higher than sdt-RSRP-Threshold;
or
1> if sdt-RSRP-Threshold is not configured :
  2> if the Serving Cell is configured with supplementary uplink as specified in
  3GPP TS 38.331 and
  2> if the RSRP of the downlink pathloss reference is less than rsrp-ThresholdSSB-
  SUL :
      3> select the SUL carrier.
  2> else:
      3> select the NUL carrier.
  2> if CG-SDT is configured on the selected UL carrier, and TA for CG-SDT is valid
  according to clause 5.27.2 in the first available CG occasion for initial CG-SDT
  transmission with CCCH message according to clause 5.8.2; and
  2> if, for each RB having data available for transmission,
  configuredGrant Type1Allowed, if configured, is configured with value true for the
  corresponding logical channel; and
  2> if at least one SSB configured for CG-SDT with SS-RSRP above cg-SDT-RSRP-
  ThresholdSSB is available:
      3> indicate to the upper layers that the conditions for initiating SDT
      procedure are fulfilled;
    3> perform CG-SDT procedure on the selected UL carrier according to clause
  5.8.2.
  2> else if a set of Random Access resources for performing RA-SDT are selected
  according to clause 5.1.1b on the selected UL carrier:
      3> if cg-SDT-TimeAlignmentTimer is running, consider cg-SDT-
      TimeAlignmentTimer as expired and perform the corresponding actions in
      clause 5.2;
      3> indicate to the upper layers that the conditions for initiating SDT
      procedure are fulfilled.
  2> else:
      3> indicate to the upper layers that the conditions for initiating SDT
      procedure are not fulfilled.
1> else:
  2> indicate to the upper layers that the conditions for initiating SDT procedure
  are not fulfilled.
```

If RA-SDT is selected above and after the RA procedure is successfully completed (see e.g., [TS38321] § 5.1.6), the UE 602 monitors the PDCCH addressed to cell radio network temporary identifier (C-RNTI) received in an RA response until the RA-SDT procedure is terminated. If CG-SDT is selected above and after the initial transmission for CG-SDT is performed, the UE 602 monitors the PDCCH addressed to C-RNTI as stored in a UE Inactive AS context as specified in [TS38331] and configured scheduled (CS)-radio network temporary identifier (RNTI) until the CG-SDT procedure is terminated. See e.g., [TS38321] § 5.27.2 and/or table 1.4-12 shown infra.

TABLE 1.4-12
5.27.2 TA Validation for CG-SDT
RRC configures the following parameters for TA validation for CG-SDT:

| | |
|---|---|
| - | cg-SDT-RSRP-ChangeThreshold: RSRP threshold for the increase/decrease of RSRP for |
| | time alignment validation. |

The MAC entity shall, upon the reception of CG-SDT configuration:

1> store the RSRP of the downlink pathloss reference with the current RSRP value of
the downlink pathloss reference as in TS 38. 331 [5] .

The MAC entity shall consider the TA of the initial CG-SDT transmission with CCCH
message to be valid when the following conditions are fulfilled:

1> The RSRP values for the stored downlink pathloss reference and the current
downlink pathloss reference are valid according to TS 38. 133 [11] ; and
1> Compared to the stored downlink pathloss reference RSRP value, the current RSRP
value of the downlink pathloss reference calculated as specified in TS 38.133 [11]
has not increased/decreased by more than cg-SDT-RSRP-ChangeThreshold, if
configured; and
1> cg-SDT-TimeAlignmentTimer is running.

In some embodiments, the initiation procedure may be updated or changed according to one or more of the following SDT initiation conditions.

A first example update/change includes: if partial resume of RBs configured for MO-SDT and/or MT-SDT is allowed (as discussed in sections 1.4.2 and 1.4.3), the applicable configured RBs may also be updated to the initiation procedure in order to only apply to MO-SDT and/or MT-SDT. For example, when mentioned “radio bearers configured for SDT” in [TS38331] or [TS38321], the specification can be revised to clarify whether it refers to RB(s) associated with MO-SDT, RB(s) associated with MT-SDT, or any of them (e.g., any SDT RB).

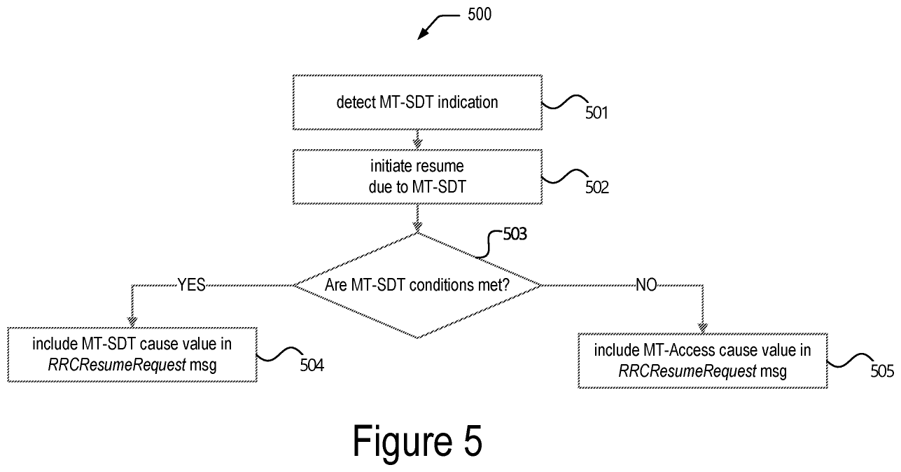

A second example update/change includes: when the UE 602 detects the MT-SDT indication for the UE 602, the UE 602 triggers the initiation of resume due to MT-SDT. However, if there is any issue (e.g., conditions required to initiate MT-SDT session are not met as shown by FIG. 5), the UE 602 continues the resume (or autonomously fallbacks to initiate the resume) procedure defined for a legacy MT access.

FIG. 5 depicts an example process 500 performed by a UE 602 to determine a resume cause value to use when detecting MT-SDT indication for a given UE. Process 500 beings at operation 501 where the UE 602 detects an MT-SDT indication, which may be included in a paging msg. At operation 502, the UE 602 initiates a resume procedure (e.g., RRC connection resume and/or the like) based on the MT-SDT indication. At operation 503, the UE 602 determines whether one or more MT-SDT conditions have been met. If any of the MT-SDT conditions have been met, at operation 504 the UE 602 includes an MT-SDT resume cause value in an RRCResumeRequest msg. In some examples, the UE 602 sets the ResumeCause value in a ResumeCause IE to “mt-SDT” at operation 504. If the MT-SDT conditions have not been met, at operation 505 the UE 602 includes an MT-Access cause value in RRCResumeRequest msg. In some examples, the UE 602 sets the ResumeCause value in a ResumeCause IE to “mt-Access” at operation 505.

For example, if the UE 602 checks its radio conditions and if they are not appropriate to perform SDT (503), the UE 602 performs legacy resume due to normal paging (505). In some examples, for checking the radio conditions (503), the UE 602 could use the same RSRP threshold as the thresholds defined in Rel-17 for MO-SDT (e.g., sdt-RSRP-Threshold). When the RSRP of the DL pathloss reference is higher than the sdt-RSRP-Threshold (503) or when sdt-RSRP-Threshold is not configured, the UE 602 continues or could continue initiation of resume due to MT-SDT and a new resume cause value for MT-SDT (e.g., “mt-SDT”) can be included in RRCResumeRequest msg (504). However, when the RSRP of the DL pathloss reference is not higher than sdt-RSRP-Threshold (503), the UE 602 continues initiation of resume due to a Mobile Terminate (MT) access and a resume cause value of MT-access (e.g., “mt-Access”) is included in the RRCResumeRequest msg (505). Even though the NW triggered MT-SDT, the UE 602 autonomously continues (or falls back) to the legacy resume as its radio conditions are not good enough to perform SDT.

In another example, if the UE 602 checks its radio conditions and if they are not appropriate to perform SDT (503), the UE 602 performs legacy resume due to normal paging (505). In some examples, for checking the radio conditions (503), the UE 602 uses an RSRP threshold for UE to determine whether to perform SDT procedure initiated for MT-SDT (“sdt-RSRP-ThresholdMT”). When the RSRP of the DL pathloss reference is higher than the sdt-RSRP-ThresholdMT (503) or when sdt-RSRP-ThresholdMT is not configured, the UE 602 initiates the resume procedure based on the MT-SDT indication and a new resume cause value for MT-SDT (e.g., “mt-SDT”) is included in an RRCResumeRequest msg (504). When the RSRP of the DL pathloss reference is not higher than sdt-RSRP-ThresholdMT (503), the UE 602 initiates the resume procedure according to the MT access and a resume cause value of MT-access (e.g., “mt-Access”) is included in the RRCResumeRequest msg (505). Even though the NW triggered MT-SDT, the UE 602 autonomously continues (or falls back) to the legacy resume as its radio conditions are not good enough to perform SDT.

A third example update/change includes: when the UE 602 detects an MT-SDT indication for the UE 602 and at the same time, MO data is available (e.g., MO-SDT or non-MO-SDT), a collision operation is performed. The collision operation can be handled in different ways.

In a first approach, collisions of MT-SDT (small data) with any UL data could be left up to UE implementation, and there no need to specify UE's 602 operation for this scenario. Here, the UE 602 may use either MO-SDT or MT-SDT approaches.

In a second approach, UE behavior varies depending on the UL data stored in buffers. In case UL traffic is non-SDT traffic, the UE 602 initiates normal resume (instead of “SDT”) in which case MT-SDT resume cause should not be used, but instead MT-Access could be used to indicate that UE 602 is responding to a paging but request its transition to CONNECTED. Additionally or alternatively, the UE 602 initiates resume for MT-SDT and the NW decides later what to do. For example, after receiving a non-SDT indication, such as over DCCH (e.g., nonSDT-DataIndication included in UEAssistanceInformation msg), the NW can know that there is non-SDT data in the UE's 602 buffer and transition the UE 602 from the SDT state to CONNECTED state.

In case UL traffic is for SDT traffic, the UE 602 checks whether MO-SDT criteria defined in Rel-17 (e.g., RSRP check defined for SDT) are met for the UE 602 to initiate MO-SDT. If SDT criteria are met, the UE 602 resumes for SDT via MO-SDT resources including the MT-SDT resume case as well as UL SDT data in the 1^{st} UL transmission. If SDT criteria are not met, the UE 602 cannot initiate SDT and instead initiates normal resume (instead of SDT). For this case, the resume cause would be MT-Access to indicate that the UE 602 responds to paging even though it was MT-SDT paging. Additionally or alternatively, the UE 602 initiates resume for MT-SDT and the NW decides later what to do. For example, after receiving a buffer status report (BSR), the NW can maintain the UE 602 in the SDT state for subsequent UL SDT traffic or even transition the UE 602 to the CONNECTED state if necessary.

In a third approach, the UE 602 always resumes for MT-SDT, for example, response to MT-SDT indication has priority regardless of whether there is any UL data or not (SDT or non-SDT). This approach would allow the NW to decide what to do next for example based on UE's 602 input, such as via BSR for SDT data if the RB is resumed or the nonSDT-DataIndication included in UEAssistanceInformation msg for non-SDT data. Additionally or alternatively, a new SDT indication can be defined (e.g., SDT-DataIndication included in UEAssistanceInformation msg) for UE 602 to indicate to the NW when SDT data is in UE's 602 buffers of SDT RBs that are still suspended. In these cases, the NW may decide to keep the UE 602 in the SDT state to allow further UL/DL SDT traffic exchange, move the UE 602 to the CONNECTED state, or release the UE 602 back to the INACTIVE state or IDLE state.

It should be noted that, when the UE 602 has an ongoing SDT session initiated due to MT-SDT indication, the UE 602 may send UEAssistanceInformation msg including nonSDT-DataIndication to indicate the NW that UL non-SDT data is available at the UE 602.

### 1.4.3. UE Radio Capabilities for MT-SDT

In some implementations, a new UE radio capability can be defined for the UE 602 to indicate its support for MT-SDT to the NW. In some implementations, an MT-SDT capability is defined as independent/standalone feature to be used with any RB. In other implementations, an MT-SDT capability (or MT-DRB-SDT capability) is defined as independent/standalone feature to be used with any DRB and another MT-SDT-SRB capability is defined when MT-SDT is to be sent over SRB. In other implementations, an MT-SDT capability is defined to be dependent to the support and/or configuration of Rel-17 SDT features (e.g., RA-SDT, CG-SDT, and/or SRB-SDT).

### 1.5. Paging Reception and Resume Aspects

### 1.5.1. Reception of Paging Messages by UEs

The purpose of the paging procedure is to transmit paging information to a UE 602 in RRC_IDLE or RRC_INACTIVE, and to transmit paging information for a layer 2 (L2) UE-to-Network (U2N) Remote UE 602 in RRC_IDLE or RRC_INACTIVE to its serving L2 U2N Relay UE 602 in any RRC state. A U2N Remote UE 602 is a UE 602 that communicates with the network (NW) (e.g., a RAN 604 and/or a RAN node 614) via a U2N Relay UE 602, and a U2N Relay UE 602 is a UE 602 that provides functionality to support connectivity to the network for U2N Remote UE(s).

The NW initiates the paging procedure by transmitting a Paging message at the UE's 602 paging occasion as specified in 3GPP TS 38.304. The NW may address multiple UEs 602 within a Paging message by including one PagingRecord for each UE 602. The NW may also include one or multiple TMGI(s) in the Paging message to page UEs 602 for specific MBS multicast session(s).

Upon receiving the Paging message by the UE 602 or receiving PagingRecord from its connected L2 U2N Relay UE 602 by a L2 U2N Remote UE 602, the UE 602 performs the following:

If the UE 602 is in RRC_IDLE, for each of the PagingRecord (if any) included in the Paging message, or if the UE 602 is in RRC_IDLE, for the PagingRecord (if any) included in the UuMessageTransferSidelink message received from the connected L2 U2N Relay UE 602: if the ue-Identity included in the PagingRecord matches the UE 602 identity allocated by upper layers and if upper layers indicate the support of paging cause: forward the ue-Identity, accessType (if present) and paging cause (if determined) to the upper layers; else: forward the ue-Identity and accessType (if present) to the upper layers.

If the UE 602 is in RRC_INACTIVE, for each of the PagingRecord (if any) included in the Paging message, or if the UE 602 is in RRC_INACTIVE, for the PagingRecord (if any) included in the UuMessageTransferSidelink message received from the connected L2 U2N Relay UE 602: if the ue-Identity included in the PagingRecord matches the UE's 602 stored fullI-RNTI and if the UE 602 is configured by upper layers with Access Identity 1: initiate the RRC connection resumption procedure according to [TS38331] § 5.3.13 with resumeCause set to mps-PriorityAccess; else if the UE 602 is configured by upper layers with Access Identity 2: initiate the RRC connection resumption procedure according to [TS38331] § 5.3.13 with resumeCause sct to mes-PriorityAccess; else if the UE 602 is configured by upper layers with one or more Access Identities equal to 11-15: initiate the RRC connection resumption procedure according to [TS38331] § 5.3.13 with resumeCause set to highPriorityAccess; else if mt-SDT indication was included in the paging message and if the conditions for initiating SDT for a resume procedure initiated in response to RAN paging according to [TS38331] § 5.3.13.1b are fulfilled: initiate the RRC connection resumption procedure according to [TS38331] § 5.3.13 with resumeCause set to mt-SDT: else: initiate the RRC connection resumption procedure according to 5.3.13 with resumeCause set to mt-Access. In some examples, if both conditions for initiating MT-SDT and MO-SDT according to [TS38331] § 5.3.13.1b are fulfilled, the UE 602 may initiate the RRC connection resumption procedure for MT-SDT or MO-SDT based on implementation. Additionally or alternatively, a MUSIM UE 602 may not initiate the RRC connection resumption procedure, e.g. when it decides not to respond to the Paging message due to UE implementation constraints as specified in 3GPP TS 24.501.

If the UE 602 is in RRC_INACTIVE, for each of the PagingRecord (if any) included in the Paging message, or if the UE 602 is in RRC_INACTIVE, for the PagingRecord (if any) included in the UuMessageTransferSidelink message received from the connected L2 U2N Relay UE 602: if the ue-Identity included in the PagingRecord matches the UE 602 identity allocated by upper layers, and if upper layers indicate the support of paging cause: forward the ue-Identity, accessType (if present) and paging cause (if determined) to the upper layers; else: forward the ue-Identity and accessType (if present) to the upper layers; and perform the actions upon going to RRC_IDLE as specified in [TS38331] § 5.3.11 with release cause ‘other’.

If the UE 602 is in RRC_IDLE, for each TMGI included in pagingGroupList (if any) included in the Paging message: if the UE 602 has joined an MBS session indicated by the TMGI included in the pagingGroupList: forward the TMGI to the upper layers.

If the UE 602 is in RRC_INACTIVE and the UE 602 has joined one or more MBS session(s) indicated by the TMGI(s) included in the pagingGroupList: if PagingRecordList is not included in the Paging message; or if none of the ue-Identity included in any of the PagingRecord matches the UE identity allocated by upper layers or the UE's 602 stored fullI-RNTI: initiate the RRC connection resumption procedure according to [TS38331] § 5.3.13 with resumeCause set as follows: set the resumeCause to mps-PriorityAccess if the UE 602 is configured by upper layers with Access Identity 1, set the resumeCause to mes-PriorityAccess if the UE 602 is configured by upper layers with Access Identity 2, set the resumeCause to highPriorityAccess if the UE 602 is configured by upper layers with one or more Access Identities equal to 11-15, else: set the resume Cause to mt-Access; else if the ue-Identity included in any of the PagingRecord matches the UE identity allocated by upper layers: forward the TMGI(s) to the upper layers;

If the UE 602 is acting as a L2 U2N Relay UE 602, for each of the PagingRecord (if any) included in the Paging message: if the ue-Identity included in the PagingRecord in the Paging message matches the UE identity in sl-PagingIdentityRemoteUE included in sl-PagingInfo-RemoteUE received in RemoteUEInformationSidelink message from a L2 U2N Remote UE 602: initiate the Uu Message transfer in sidelink to that UE 602 as specified in [TS38331] § 5.8.9.9.

The paging message is used for the notification of one or more UEs 602. The signaling radio bearer for the paging message is N/A; the RLC-SAP is TM; the logical channel is paging control channel (PCCH); and the message direction is NW to UE 602. An example paging message is shown by table 1.5-1 and paging message field descriptions are shown by table 1.5-2.

TABLE 1.5-1
Paging message

-- ASN1 START
-- TAG-PAGING-START

| Paging : := | SEQUENCE { | |
|---|---|---|
| pagingRecordList | PagingRecordList | OPTIONAL, -- Need N |
| lateNonCriticalExtension | OCTET STRING | OPTIONAL, |
| nonCriticalExtension | Paging-v1700-IEs | OPTIONAL |

}

| Paging-v1700-IEs : := | SEQUENCE { | |
|---|---|---|
| pagingRecordList-v1700 | PagingRecordList-v1700 | OPTIONAL, -- Need N |
| pagingGroupList-r17 | PagingGroupList-r17 | OPTIONAL, -- Need N |
| nonCriticalExtension | Paging-v1800-Ies | OPTIONAL |

}

| Paging-v1800-IEs : := | SEQUENCE { | |
|---|---|---|
| pagingRecordList-v1800 | PagingRecordList-v1800 | OPTIONAL, -- Need N |
| pagingGroupList-v1800 | PagingGroupList-v1800 | OPTIONAL, -- Need N |
| nonCriticalExtension | SEQUENCE { } | OPTIONAL |

}

| PagingRecordList : := | SEQUENCE (SIZE(1..maxNrofPageRec)) OF PagingRecord | |
|---|---|---|
| PagingRecordList-v1700 : | SEQUENCE (SIZE(1..maxNrofPageRec)) OF PagingRecord-v1700 | |
| PagingGroupList-r17 : := | SEQUENCE (SIZE(1..maxNrofPageGroup-r17)) OF TMGI-r17 | |
| PagingRecordList-v1800 : := | SEQUENCE (SIZE(1..maxNrofPageRec)) OF PagingRecord-v1800 | |
| PagingGroupList-v1800 : := | SEQUENCE (SIZE(1..maxNrofPageGroup-r17)) OF GroupPaging-r18 | |
| PagingRecord : : = | SEQUENCE { | |
| ue-Identity | PagingUE-Identity, | |
| accessType | ENUMERATED {non3GPP} | OPTIONAL, -- Need N |

...
}

| PagingRecord-v1700 : := | SEQUENCE { | |
|---|---|---|
| pagingCause-r17 | ENUMERATED {voice} | OPTIONAL -- Need N |

}

| PagingRecord-v1800 : : = | SEQUENCE { | |
|---|---|---|
| mt-SDT | ENUMERATED {true} | OPTIONAL -- Need N |

}

| | |
|---|---|
| PagingUE-Identity : := | CHOICE { |
| ng-5G-S-TMSI | NG-5G-S-TMSI, |
| fullI-RNTI | I-RNTI -Value, |

...
}

| GroupPaging-r18 : : = | SEQUENCE { | |
|---|---|---|
| inactiveReceptionAllowed-r18 | ENUMERATED {true} | OPTIONAL -- Need N |

}
-- TAG-PAGING-STOP
-- ASN1 STOP

TABLE 1.5-2
PagingRecord field descriptions

accessType
Indicates whether the Paging message is originated due to the PDU sessions from the non-3GPP access.
inactiveReceptionAllowed
Indicates whether the UE with a valid PTM configuration for a TMG/ in the PagingGroupList stays in
RRC INACTIVE to receive the corresponding MBS multicast session.
mt-SDT
Mobile Terminated SDT indication. The network includes mt-SDT indication in paging message only if the UE's
I-RNTI is included in the paging message.
pagingRecordList
If the network includes pagingRecordList-v1700, it includes the same number of entries, and listed in the same
order, as in pagingRecordList (i.e. without suffix). If the network includes pagingRecordList-v1800, it includes the
same number of entries, and listed in the same order, as in pagingRecordList (i.e. without suffix).
pagingCause
Indicates whether the Paging message is originated due to IMS voice. If this field is present, it implies that the
corresponding paging entry is for IMS voice. If upper layers indicate the support of paging cause and if this field is
not present but pagingRecordList-v1700 is present, it implies that the corresponding paging entry is for a service
other than IMS voice. Otherwise, paging cause is undetermined.
pagingGroupList
If the network includes pagingGroupList-v1800, it includes the same number of elements, and listed in the same
order, as in pagingGroupList-r17. The first element corresponds to the first TMGI in pagingGroupList-r17. The
second element corresponds to the second TMGI in pagingGroupList-r17, and so on.

### 1.5.2. RRC Connection Resume for Initiating Sdt Aspects

The purpose of the RRC connection resume procedure is to resume a suspended RRC connection, including resuming SRB(s), DRB(s), and multicast MRB(s), to perform an RAN-based Notification Area (RNA) update, and/or to initiate SDT in RRC_INACTIVE.

The RRC connection resume procedure includes the UE 602 sending an RRCResumeRequest msg or RRCResumeRequest1 msg to the NW. In some examples, the NW sends an RRCResume msg to the UE 602 based on the RRCResumeRequest msg or RRCResumeRequest1 msg, and the UE 602 sends an RRCResumeComplete msg to the NW. In some examples, the NW sends an RRCSetup msg to the UE 602 based on the RRCResumeRequest msg or RRCResumeRequest msg, and the UE 602 sends an RRCSetupComplete msg to the NW. The UE 602 initiates the resume procedure (e.g., transmits the RRCResumeRequest msg or RRCResumeRequest msg) when upper layers or access stratum (AS) (when responding to RAN paging, upon triggering RNA updates while the UE 602 is in RRC_INACTIVE, upon requesting multicast reception as specified in [TS38331] § 5.3.13.1d, for NR sidelink communication/discovery/V2X sidelink communication as specified in [TS38331] § 5.3.13.1a, for NR sidelink positioning as specified in [TS38331] § 5.3.13.1c, for requesting configuration for SRS for positioning, for activation of preconfigured positioning SRS in RRC_INACTIVE, upon receiving RRCRelease message including resumeIndication) requests the resume of a suspended RRC connection or requests the resume for initiating SDT as specified in [TS38331] § 5.3.13.1b.

The RRCResume Request message is used to request the resumption of a suspended RRC connection or perform an RNA update. The signalling radio bearer is SRB0; the RLC-SAP is TM; the logical channel is a common control channel (CCCH); and the message direction: UE 602 to NW. Table 1.5-3 shows an example RRCResumeRequest message and table 1.5-4 shows field descriptions for the RRCResumeRequest message.

TABLE 1.5-3
RRCResumeRequest message

| -- ASN1 START | |
|---|---|
| -- TAG-RRCRESUMEREQUEST-START | |
| RRCResumeRequest ::= | SEQUENCE { |
| rrcResumeRequest | RRCResumeRequest-IEs |
| } | |
| RRCResumeRequest-IEs ::= | SEQUENCE { |
| resumeIdentity | ShortI-RNTI-Value, |
| resumeMAC-I | BIT STRING (SIZE (16)), |
| resumeCause | ResumeCause, |
| spare | BIT STRING (SIZE (1)) |

}
-- TAG-RRCRESUMEREQUEST-STOP
-- ASN1STOP

TABLE 1.5-4
RRCResumeRequest-IEs field descriptions

resumeCause
Provides the resume cause for the RRC connection resume request as
provided by the upper layers or RRC. The network is not expected
to reject an RRCResumeRequest due to unknown cause value being
used by the UE.
resumeIdentity
UE identity to facilitate UE context retrieval at gNB.
resumeMAC-I
Authentication token to facilitate UE authentication at gNB. The 16
least significant bits of the MAC-I calculated using the AS
security configuration as specified in [TS38331] § 5.3.13.3.

The RRCResumeRequest1 message is used to request the resumption of a suspended RRC connection or perform an RNA update. The signalling radio bearer is SRB0; the RLC-SAP is TM; the logical channel is CCCH1; and the message direction is UE 602 to NW. Table 1.5-5 shows an example RRCResumeRequest1 message and table 1.5-6 shows field descriptions for the RRCResumeRequest1 message.

TABLE 1.5-5
RRCResumeRequest1 message

| -- ASN1START | |
|---|---|
| -- TAG-RRCRESUMEREQUEST1-START | |
| RRCResumeRequest1 ::= | SEQUENCE { |
| rrcResumeRequest1 | RRCResumeRequest1-IEs |
| } | |
| RRCResumeRequest1-IEs : : = | SEQUENCE { |
| resumeIdentity | I-RNTI -Value, |
| resumeMAC-I | BIT STRING (SIZE (16)), |
| resumeCause | ResumeCause, |
| spare | BIT STRING (SIZE (1)) |

}
-- TAG-RRCRESUMEREQUEST1-STOP
-- ASNISTOP

TABLE 1.5-6
RRCResumeRequest1-IEs field descriptions

resumeCause
Provides the resume cause for the RRCResumeRequest1 as provided by
the upper layers or RRC. A gNB is not expected to reject an
RRCResumeRequest1 due to unknown cause value being used by the UE.
resumeIdentity
UE identity to facilitate UE context retrieval at gNB.
resumeMAC-I
Authentication token to facilitate UE authentication at gNB. The 16
least significant bits of the MAC-I calculated using the AS
security configuration as specified in [TS38331] § 5.3.13.3.

In any of the examples discussed herein, the inactive RNTI (I-RNTI) is used to identify the suspended UE context of a UE 602 in RRC_INACTIVE state. The network assigns an I-RNTI to the UE 602 when moving from RRC_CONNECTED to RRC_INACTIVE in an RRCRelease message within SuspendConfig. Two types of I-RNTIs are defined, including fullI-RNTI and shortI-RNTI. The NW informs the UE 602 in system information block 1 (SIB1) which I-RNTI is to be used while resuming the connection (e.g., in the RRCResumeRequest msg of RRCResumeRequest1 msg). Here, the SIB1 can include a useFullResumeID field/IE to indicate which resume identifier and resume request message should be used. In some examples, the UE 602 uses fullI-RNTI and RRCResumeRequest1 if the field is present, or short1-RNTI and RRCResumeRequest if the field is absent. In some implementations, the fullI-RNTI is a bit string of length 40 bits while the short-RNTI is a bit string of length 24 bits.

The ResumeCause information element (IE) is used to indicate the resume cause in RRCResumeRequest, RRCResumeRequest1 and UEAssistanceInformation. An example ResumeCause IE is shown by table 1.5-7.

TABLE 1.5-7
ResumeCause information element

-- ASN1 START
-- TAG-RESUMECAUSE-START

| | |
|---|---|
| ResumeCause ::= | ENUMERATED {emergency, highPriorityAccess, mt-Access, mo-Signalling, |
| | mo-Data, mo-VoiceCall, mo-VideoCall, mo-SMS, rna-Update, mps- |
| | PriorityAccess, mos-PriorityAccess, mt-SDT, |
| | srs-PosConfigOrActivationReq-v1800, spare3, spare2, spare1 } |

-- TAG-RESUMECAUSE-STOP
-- ASN1STOP

In some implementations, the conditions for initiating SDT include a UE 602 in RRC_INACTIVE initiating the resume procedure for SDT when some or all of the following conditions are fulfilled: for the resume procedure initiated by the upper layers (e.g., the mobile originated (MO) case): SIB1 includes sdt-ConfigCommon; sdt-Config is configured; all the pending data in UL is mapped to the radio bearers configured for SDT; for an (e)RedCap UE 602 when (e)RedCap-specific initial DL BWP includes no CD-SSB, ncd-SSB-RedCapInitialBWP-SDT is configured; and lower layers indicate that conditions for initiating MO-SDT as specified in [TS38321] are fulfilled.

Additionally or alternatively, the conditions for initiating SDT include a UE 602 in RRC_INACTIVE initiating the resume procedure for SDT when some or all of the following conditions are fulfilled for the resume procedure initiated in response to RAN paging (e.g., the mobile terminated (MT) case): an mt-SDT indication was included in the paging message for the UE's 602 stored fullI-RNTI; and lower layers indicate that conditions for initiating MT-SDT as specified in [TS38321] are fulfilled. In some examples, how the UE 602 determines that all pending data in UL is mapped to RBs configured for SDT is left to UE implementation.

### 1.5.3. MAC Layer SDT Aspects

The MAC entity may be configured by the RRC layer/entity with SDT and the SDT procedure may be initiated by RRC layer for MO-SDT or MT-SDT. The SDT procedure initiated for MO-SDT can be performed either by RA procedure with 2-step RA type or 4-step RA type (e.g., RA-SDT) or by configured grant Type 1 (e.g., CG-SDT). The SDT procedure initiated for MT-SDT can be performed either by RA procedure with 2-step RA type or 4-step RA type (e.g., RA-SDT is not applicable as specified in [TS38321] § 5.1.1b) or by configured grant Type 1 (e.g., CG-SDT). The RRC entity/layer configures the parameters shown by table 1.5-8 for the SDT procedure.

TABLE 1.5-8
parameters for SDT procedure

| Parameter | Description |
|---|---|
| sdt-DataVolumeThreshold | data volume threshold for the UE to determine whether to |
| | perform SDT procedure initiated for MO-SDT |
| sdt-RSRP-Threshold | RSRP threshold for UE to determine whether to perform SDT |
| | procedure initiated for MO-SDT |
| sdt-RSRP-ThresholdMT | RSRP threshold for UE to determine whether to perform SDT |
| | procedure initiated for MT-SDT |
| cg-SDT-RSRP-ThresholdSSB | an RSRP threshold configured for SSB selection for CG-SDT |
| cg-MT-SDT-MaxDurationToNextCG-Occasion | time threshold which is used by the UE to determine whether to |
| | perform CG-SDT for MT-SDT |
| cg-SDT-MaxDurationToNextCG-Occasion | time threshold configured per logical channel which is used by |
| | the UE to determine whether to perform CG-SDT for MO-SDT |

The following UE variable(s) is/are used for the SDT procedure: MAX_DURATION_TO_NEXT_CG_OCCASION; and RSRP_THRESHOLD. The MAC entity, if initiated by the upper layers for SDT procedure, performs the following operations:

If SDT procedure is initiated for MO-SDT as specified in [TS38331]: set the MAX_DURATION_TO_NEXT_CG_OCCASION to the shortest value of cg-SDT-MaxDurationToNextCG-Occasion, if configured, among all the logical channel configured with this parameter by upper layer(s) (e.g., RRC and/or the like) and having data for transmission; set the RSRP_THRESHOLD to the value of sdt-RSRP-Threshold, if configured; else if SDT procedure is initiated in for MT-SDT as specified [TS38331]: sct the MAX_DURATION_TO_NEXT_CG_OCCASION to the value of cg-MT-SDT-MaxDurationToNextCG-Occasion (if configured), set the RSRP_THRESHOLD to the value of sdt-RSRP-ThresholdMT if sdt-RSRP-ThresholdMT is configured; and set the RSRP_THRESHOLD to the value of sdt-RSRP-Threshold if sdt-RSRP-Threshold is configured.

If the SDT procedure is initiated for MO-SDT as specified in [TS38331], and the data volume of the pending UL data across all RBs configured for SDT is less than or equal to sdt-DataVolumeThreshold, or if the SDT procedure is initiated for MT-SDT as specified in [TS38331]; and if the RSRP of the DL pathloss reference is higher than RSRP_THRESHOLD or if RSRP_THRESHOLD is not set: If the Serving Cell is configured with supplementary uplink as specified in [TS38331]; and if the RSRP of the DL pathloss reference is less than an RSRP threshold for the selection between the NUL carrier and the SUL carrier (“rsrp-ThresholdSSB-SUL”): select the supplementary UL (SUL) carrier; else: select the normal UL (NUL) carrier. If CG-SDT is configured on the selected UL carrier, and TA for CG-SDT is valid according to [TS38321] § 5.27.2 in the first available CG occasion for initial CG-SDT transmission with CCCH message according to [TS38321] § 5.8.2; and if the SDT procedure is initiated for MO-SDT as specified in [TS38331], and, for each RB having data available for transmission, configuredGrantType1Allowed, if configured for CG-SDT, is configured with value true for the corresponding logical channel, or if the SDT procedure is initiated for MT-SDT as specified in [TS38331]; and if at least one SSB configured for CG-SDT with SS-RSRP above cg-SDT-RSRP-ThresholdSSB is available, and if either the time gap between the initiation of the SDT procedure and first available CG occasion for initial CG-SDT transmission with CCCH message according to [TS38321] § 5.8.2 is less than MAX_DURATION_TO_NEXT_CG_OCCASION, or if the MAX_DURATION_TO_NEXT_CG_OCCASION is not set: indicate to the upper layers that the conditions for initiating SDT procedure are fulfilled, and perform CG-SDT procedure on the selected UL carrier according to [TS38321] § 5.8.2. Else if a set of RA resources for RA-SDT is configured and can be selected according to [TS38321] § 5.1.1b on the selected UL carrier on the BWP configured by initialUplinkBWP-RedCap, if configured for a RedCap UE; otherwise, on the BWP configured by initialUplinkBWP; or if the SDT procedure is initiated for MT-SDT as specified in [TS38331]: if cg-SDT-TimeAlignmentTimer is running (the cg-SDT-TimeAlignmentTimer controls how long the MAC entity considers the uplink transmission for CG-SDT to be uplink time aligned), consider cg-SDT-TimeAlignmentTimer as expired and perform the corresponding actions in [TS38321] § 5.2, indicate to the upper layers (e.g., RRC and/or the like) that the conditions for initiating SDT procedure are fulfilled; else, indicate to the upper layers (e.g., RRC and/or the like) that the conditions for initiating SDT procedure are not fulfilled.

Otherwise, if the aforementioned conditions is/are not met, then indicate to the upper layers (e.g., RRC and/or the like) that the conditions for initiating SDT procedure are not fulfilled.

If an RA procedure is selected for the SDT procedure initiated for MO-SDT or MT-SDT and after the RA procedure is successfully completed (see e.g., [TS38321] § 5.1.6), the UE 602 monitors PDCCH addressed to C-RNTI received in an RA response until the SDT procedure is terminated. If CG-SDT is selected above and after the initial transmission for CG-SDT is performed, the UE 602 monitors PDCCH addressed to C-RNTI as stored in the UE Inactive AS context as specified in [TS38331] and CS-RNTI until the SDT procedure is terminated.

In some examples, for the SDT procedure, the MAC entity also considers the suspended RBs configured with SDT for data volume calculation. It is up to the UE's implementation how the UE calculates the data volume for the suspended RBs. Size of the CCCH message is not considered for data volume calculation. Additionally or alternatively, when the UE 602 determines if there is an SSB with SS-RSRP above cg-SDT-RSRP-ThresholdSSB, the UE 602 uses the latest unfiltered L1-RSRP measurement.

Additionally or alternatively, the RRC entity/layer configures the following parameters for timing advance (TA) validation for CG-SDT: cg-SDT-RSRP-ChangeThreshold which is an RSRP threshold for the increase/decrease of RSRP for time alignment validation. The MAC entity, upon the reception of CG-SDT configuration, stores the current RSRP of the DL pathloss reference for TA validation as defined in [TS38331] § 5.7.17.

The MAC entity considers the TA of the initial CG-SDT transmission with CCCH message to be valid when the following conditions are fulfilled: the RSRP values for the stored DL pathloss reference and the current DL pathloss reference are valid according to [TS38133]; compared to the stored DL pathloss reference RSRP value, the current RSRP value of the DL pathloss reference calculated as specified in [TS38133] has not increased/decreased by more than cg-SDT-RSRP-ChangeThreshold, if configured; and the cg-SDT-TimeAlignmentTimer is running.

### 2. Example Network, System, and Device Configurations and Arrangements

FIG. 6 depicts an example network architecture 600. The network 600 may operate in a manner consistent with 3GPP technical specifications for LTE or 5G/NR systems. However, the example embodiments are not limited in this regard and the described examples may apply to other networks that benefit from the principles described herein, such as future 3GPP systems, WiMAX systems, GSMA systems, WiFi systems, and/or the like.

The network 600 includes a UE 602, which is any mobile or non-mobile computing device designed to communicate with a RAN 604 via an over-the-air connection. The UE 602 is communicatively coupled with the RAN 604 by a Uu interface, which may be applicable to both LTE and NR systems. Examples of the UE 602 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, servers, in-vehicle infotainment system, in-car entertainment system, instrument cluster, head-up display (HUD) device, extended reality (XR) device (e.g., including augmented reality, virtual reality (VR), and/or mixed reality), onboard diagnostic device, dashtop mobile equipment, mobile data terminal, electronic engine management system, engine management system, electronic/engine control unit/module, embedded system, sensor, microcontroller, control module, networked appliance, machine-type communication device, machine-to-machine (M2M), Internet of Things (IOT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein. In some examples, the UE 602 can include desktop computers. The UE 602 may be the same or similar to any of the other UEs discussed herein such as, for example, UE 702, hardware resources 800, and/or the like.

In some examples, the network 600 includes a set of UEs 602 coupled directly with one another via a proximity services (ProSe), PC5, sidelink (SL) interface, which involves communication between two or more UEs 602 using 3GPP technology without traversing a network node. Here, the SL interface includes, for example, one or more SL logical channels (e.g., sidelink broadcast control channel (SBCCH), sidelink control channel (SCCH), and sidelink traffic channel (STCH)); one or more SL transport channels (e.g., sidelink shared channel (SL-SCH) and sidelink broadcast channel (SL-BCH)); and one or more SL physical channels (e.g., physical sidelink shared channel (PSSCH), physical sidelink control channel (PSCCH), physical sidelink Feedback channel (PSFCH), physical sidelink broadcast channel (PSBCH), and/or the like). The UE 602 may perform blind decoding attempts of SL channels/links according to the various examples herein.

In some examples, the UE 602 can communicate with an AP 606 via an over-the-air (OTA) connection. The AP 606 manages a WLAN connection between the UE 602 and the AP 606, which is consistent with any IEEE 802 protocol (e.g., IEEE 802.11 and/or the like). Additionally, the UE 602, RAN 604, and AP 606 may utilize cellular-WLAN aggregation/integration (e.g., LWA/LWIP), which may serve to offload some/all network traffic from the RAN 604.

The RAN 604 includes one or more network access nodes (NANs) 614 (also referred to as “access network nodes”, “RAN nodes”, and/or the like). The NANs 614 terminate air-interface(s) for the UE 602 by providing access stratum protocols including RRC, PDCP, RLC, MAC, and PHY/L1 protocols. In this manner, the NANs 614 enable data/voice connectivity between the CN 640 and the UE 602. The NANs 614 may be a macrocell base station or a low power base station for providing femtocells, picocells or other like cells having smaller coverage areas, smaller user capacity, or higher bandwidth compared to macrocells; or some combination thereof. In these implementations, an NAN 614 be referred to as a BS, gNB, RAN node, cNB, ng-cNB, NodeB, RSU, TRP, and the like. The RAN 604 may have an NG-RAN architecture as discussed in 3GPP TS 38.401.

The RAN 604 (or individual NANs 614) may provide the air interface over a licensed spectrum or an unlicensed spectrum. To operate in the unlicensed spectrum, the nodes may use LAA, cLAA, and/or feLAA mechanisms based on CA technology with PCells/SCells. Prior to accessing the unlicensed spectrum, the nodes may perform medium/carrier-sensing operations based on, for example, a listen-before-talk (LBT) protocol.

The set of NANs 614 are coupled with one another via respective Xn interfaces. The Xn interfaces, which may be separated into control/user plane interfaces in some examples, allow the NANs 614 to communicate information related to handovers, data/context transfers, mobility, load management, interference coordination, and the like. The NANs 614 manage one or more cells, cell groups, component carriers (CCs), and the like to provide the UE 602 with an air interface for network access. The UE 602 may be simultaneously connected with a set of cells provided by the same or different NANs 614 of the RAN 604 or a different RAN 604. For example, the UE 602 and RAN 604 may use carrier aggregation (CA) to allow the UE 602 to connect with a set of CCs, each corresponding to a primary cell (PCell) or secondary cell (SCell). The NG-RAN 604 supports multi-radio DC (MR-DC) operation where a UE 602 is configured to utilize radio resources provided by two distinct schedulers, located in at least two different NG-RAN nodes 614 connected via a non-ideal backhaul, one NG-RAN node 614 providing NR access and the other NG-RAN node 614 providing either E-UTRA or NR access. Further details of MR-DC operation, including conditional PSCell addition (CPA) and conditional PSCell change (CPC), can be found in 3GPP TS 36.300 (“[TS36300]”), 3GPP TS 38.300 (“[TS38300]”), and 3GPP TS 37.340.

Individual UEs 602 can be configured to measure or collect radio information, and provide the radio information to one or more NANs 614. The radio information may be in the form of one or more measurement reports, and/or may include, for example, signal strength measurements, signal quality measurements, and/or the like. Each measurement report can be tagged with a timestamp and the location of the measurement (e.g., the UEs 602 current location). For example, the UE 602 can perform reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 602 can include those discussed in 3GPP TS 38.211 (“[TS38211]”), 3GPP TS 38.212 (“[TS38212]”), 3GPP TS 38.213 (“[TS38213]”), 3GPP TS 38.214 (“[TS38214]”), 3GPP TS 38.215 (“[TS38215]”), 3GPP TS 38.101-1 (“[TS38101-1]”), 3GPP TS 38.104 (“[TS38104]”), 3GPP TS 38.113 (“[TS38113]”), 3GPP TS 38.133 (“[TS38133]”), 3GPP TS 38.331 (“[TS38331]”), and/or other the like. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), sounding reference signal (SRS), and/or the like. Examples of the measurements performed/collected by individual UEs 602 and/or included in measurement reports can include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (E_{b}/N₀), energy per chip to interference power density ratio (E_{c}/I₀), energy per chip to noise power density ratio (E_{c}/N₀), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning, GNSS code measurements, GNSS carrier phase measurements; Accumulated Delta Range (ADR), channel interference measurements, thermal noise power measurements, received interference power measurements, power histogram measurements, channel load measurements, STA statistics, and/or other like measurements. Other measurements may be additionally or alternatively used, such as those discussed in [TS36214], [TS38215], 3GPP TS 38.314 (“[TS38314]”), 3GPP TS 28.552 (“[TS28552]”), 3GPP TS 32.425 (“[TS32425]”), IEEE 802.11, and/or the likc. Additionally or alternatively, any of the aforementioned measurements (or combination of measurements) may be collected by one or more NANs 614 and/or other network nodes.

The multiple access scheme for the NR physical layer (PHY) is based on orthogonal frequency division multiplexing (OFDM) with a cyclic prefix (CP). For UL, discrete Fourier transform-spread-OFDM (DFT-s-OFDM) with a CP is also supported. To support transmission in paired and unpaired spectrum, both frequency division duplex (FDD) and time division duplex (TDD) are enabled. Layer 1 (L1) is defined in a bandwidth (BW) agnostic way based on resource blocks (RBs), allowing the NR L1 to adapt to various spectrum allocations. An RB spans 12 sub-carriers with a given subcarrier spacing (SCS). A radio frame has a duration of 10 ms and includes 10 subframes with a subframe duration of 1 ms. A subframe is formed by one or multiple adjacent slots, each having 14 adjacent symbols. Further details on the frame structure are specified in 3GPP TS 38.202.

The physical channels defined in the DL include: the Physical Downlink Shared Channel (PDSCH), the Physical Downlink Control Channel (PDCCH), and the Physical Broadcast Channel (PBCH). The physical channels defined in the UL are: the Physical Random Access Channel (PRACH), the Physical Uplink Shared Channel (PUSCH), and the Physical Uplink Control Channel (PUCCH). The physical channels defined in the SL are: the PSBCH, the PSCCH, the PSFCH, and PSSCH. In addition, signals are defined as reference signals, primary synchronization signals (PSS), and secondary synchronization signals (SSS). The supported modulation schemes supported include in the downlink: QPSK, 16QAM, 64QAM, 256QAM, and 1024QAM; and in the uplink: QPSK, 16QAM, 64QAM and 256QAM for OFDM with a CP and x/2-BPSK, QPSK, 16QAM, 64QAM and 256QAM for DFT-s-OFDM with a CP.

As alluded to previously, the NG-RAN 614 provides a 5G-NR air interface (e.g., Uu interface), which may have the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (e.g., PRBs) to support data transmission under different traffic loading scenarios. A BWP containing a smaller number of PRBs can be used for data transmission with small traffic load while allowing power saving at the UE 602 and in some cases at the gNB 614a. A BWP containing a larger number of PRBs can be used for scenarios with higher traffic load.

The PHY offers information transfer services to the MAC layer and/or higher layers via transport channels”. DL transport channel types include broadcast channel (BCH), DL shared channel (DL-SCH), and paging channel (PCH); UL transport channel types include UL shared channel (UL-SCH) and random access channel(s) (RACH); and sidelink transport channel types include sidelink broadcast channel (SL-BCH) and sidelink shared channel (SL-SCH). The association of transport channels to physical channels is described in 3GPP TS 38.202.

The MAC (sub)layer provides the following services and functions: mapping between logical channels and transport channels; multiplexing/demultiplexing of MAC SDUs belonging to one or different logical channels into/from transport blocks (TB) delivered to/from the PHY on transport channels; scheduling information reporting; error correction through HARQ (one HARQ entity per cell in case of CA); priority handling between UEs 602 by means of dynamic scheduling; priority handling between logical channels of one UE 602 by means of logical channel prioritization; priority handling between overlapping resources of one UE 602; padding; and radio resource selection. A single MAC entity can support multiple numerologics, transmission timings and cells. Mapping restrictions in logical channel prioritization control which numerology(ies), cell(s), and transmission timing(s) a logical channel can use (see e.g., [TS38300] § 16.1.2).

The MAC (sub)layer provides data transfer services on logical channels. To accommodate different kinds of data transfer services, multiple types of logical channels are defined, each supporting transfer of a particular type of information. Each logical channel type is defined by what type of information is transferred. Logical channels are classified into two groups: Control channels and traffic channels. Control channels are used for the transfer of control plane information and traffic channels are used for the transfer of user plane information. The control channels include, for example, broadcast control channel (BCCH) which is a downlink channel for broadcasting system control information and can be mapped to BCH and/or to DL-SCH; paging control channel (PCCH) which is a downlink channel that carries paging messages and can be mapped to PCH; common control channel (CCCH) which is a channel for transmitting control information between UEs 602 and network (this channel is used for UEs 602 having no RRC connection with the network) and can be mapped to DL-SCH and/or UL-SCH; dedicated control channel (DCCH) which is a point-to-point bi-directional channel that transmits dedicated control information between a UE 602 and the network (used by UEs 602 having an RRC connection) and can be mapped to DL-SCH and/or UL-SCH; MBS control channel (MCCH) which is a channel for transmitting MBS-related control information and can be mapped to DL-SCH; sidelink broadcast control channel (SBCCH) which is a sidelink channel for broadcasting system control information and can be mapped to SL-BCH; and sidelink control channel (SCCH) which is a channel for transmitting control information between two or more UEs 602 and can be mapped to SL-SCH. The traffic channels include, for example, dedicated traffic channel (DTCH) for point-to-point channel, dedicated to one UE 602, for the transfer of user information (a DTCH can exist in both UL and DL) and can be mapped to DL-SCH and/or UL-SCH; MBS traffic channel (MTCH) which is a channel for transmitting MBS-related information/data and can be mapped to DL-SCH; and sidelink traffic channel (STCH) which is a channel for transmitting sidelink information/data and can be mapped to SL-SCH.

The RAN 604 is communicatively coupled to CN 640 that includes network elements and/or network functions (NFs) to provide various functions to support data and telecommunications services to customers/subscribers (e.g., UE 602). The components of the CN 640 may be implemented in one physical node or separate physical nodes. In some examples, NFV may be utilized to virtualize any or all of the functions provided by the network elements of the CN 640 onto physical compute/storage resources in servers, switches, and the like. A logical instantiation of the CN 640 may be referred to as a network slice, and a logical instantiation of a portion of the CN 640 may be referred to as a network sub-slice. In the example of FIG. 6, the CN 640 is a 5GC 640 including an Authentication Server Function (AUSF) 642, Access and Mobility Management Function (AMF) 644, Session Management Function (SMF) 646, User Plane Function (UPF) 648, Network Slice Selection Function (NSSF) 650, Network Exposure Function (NEF) 652, Network Repository Function (NRF) 654, Policy Control Function (PCF) 656, Unified Data Management (UDM) 658, Unified Data Repository (UDR), Application Function (AF) 660, and Network Data Analytics Function (NWDAF) 662 coupled with one another over various interfaces as shown. The NFs in the 5GC 640 are briefly introduced as follows. Various aspects of the various NFs in the 5GC 640 are discussed in detail in '192 and [TS23501], among many other 3GPP standards/specifications. Although not shown by FIG. 6, the system 600 may also include various NFs that are not shown such as, for example, any of those discussed in [TS23501].

The data network (DN) 636, at least in some examples, is a network hosting data-centric services such as, for example, operator services, the internet, third-party services, or enterprise networks. In some examples, the DN 636 includes one or more service networks that belong to an operator or third party, which are offered as a service to a client or UE 602. Additionally or alternatively, the DN 636 is provided by one or more servers including, for example, application (app)/content server 638, edge servers and/or edge compute nodes, cloud computing services, and/or the like. The DN 636 may be an operator external public, a private PDN, or an intra-operator packet data network, for example, for provision of IMS services. In this example, the app server 638 can be coupled to an IMS via an S-CSCF or the I-CSCF. In some implementations, the DN 636 may represent one or more local area DNs (LADNs), which are DNs 636 (or DN names (DNNs)) that is/are accessible by a UE 602 in one or more specific areas. Outside of these specific areas, the UE 602 is not able to access the LADN/DN 636. Additionally or alternatively, the DN 636 may be an edge DN 636, which is a (local) DN that supports the architecture for enabling edge applications. In these examples, the app server 638 may represent the physical hardware systems/devices providing app server functionality and/or the application software resident in the cloud or at an edge compute node that performs server function(s). In some examples, the app/content server 638 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 604 or RAN nodes 614. For example, the edge compute nodes can provide a connection between the RAN 604 and UPF 648 in the 5GC 640. The edge compute nodes can use one or more NFV instances instantiated on virtualization infrastructure within the edge compute nodes to process wireless connections to and from the RAN 614 and UPF 648. The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 602. The VI of the edge compute nodes provide virtualized environments and virtualized resources for the edge hosts, and the edge computing applications may run as VMs and/or application containers on top of the VI. Examples of the edge computing frameworks/ECTs and services deployment examples that can be used include ETSI MEC; O-RAN; 3GPP System Aspects Working Group 6 (SA6) Architecture for enabling Edge Applications as discussed in 3GPP TS 23.222, 3GPP TS 23.401, 3GPP TS 23.434, 3GPP TS 23.501 (“[TS23501]”), 3GPP TS 23.502 (“[TS23502]”), 3GPP TS 23.548 (“[TS23548]”), 3GPP TS 23.558 (“[TS23558]”), 3GPP TS 23.682, 3GPP TR 23.700-98, 3GPP TS 28.104 (“[TS28104]”), 3GPP TS 28.105 (“[TS28105]”), 3GPP TS 28.312, 3GPP TS 28.532 (“[TS28532]”), 3GPP TS 28.533 (“[TS28533]”), 3GPP TS 28.535, 3GPP TS 28.536, 3GPP TS 28.538, 3GPP TS 28.541 (“[TS28541]”), 3GPP TS 28.545 (“[TS28545]”), 3GPP TS 28.550 (“[TS28550]”), 3GPP TS 28.554 (“[TS28554]”), 3GPP TS 28.622 (“[TS28622]”), 3GPP TS 29.122, 3GPP TS 29.222, 3GPP TS 29.522, 3GPP TR 28.908, 3GPP TS 33.122 (collectively referred to as “[5GEdge]”); and/or any other ECT/framework mentioned in '192.

The interfaces of the 5GC 640 include reference points and service-based interfaces. A reference point, at least in some examples, is a point at the conjunction of two non-overlapping functional groups, elements, or entities. The reference points in the 5GC 640 include: N1, N2, N3, N4, N5, N6, N7, N8, N9, N10, N11, N12, N13, N14 (between two AMFs 644; not shown), N15, N16, and N22. Other reference points not shown in FIG. 6 can also be used, such as any of those discussed in [TS23501]. The service-based representation of FIG. 6 represents NFs within the control plane that enable other authorized NFs to access their services. A service-based interface (SBI), at least in some examples, is an interface over which an NF can access the services of one or more other NFs. In some implementations, the service-based interfaces are API-based interfaces (e.g., HTTP/2, RESTful, SOAP, and/or any other API or web service) that can be used by an NF to call or invoke a particular service or service operation. The SBIs in the 5GC 640 include: Namf, Nsmf, Nnef, Npcf, Nudm, Naf, Nnrf, Nnssf, Nausf. Other service-based interfaces (e.g., Nudr, N5g-eir, and Nudsf) not shown in FIG. 6 can also be used, such as any of those discussed in [TS23501].

FIG. 7 illustrates a wireless network 700, which includes a UE 702 in wireless communication with a NAN 704. The UE 702 may be the same or similar to, and substantially interchangeable with any of the of the UEs discussed herein such as, for example, UE 602, hardware resources 800, and/or the like. The NAN 704 may be the same or similar to, and substantially interchangeable with any of the NANs discussed herein such as, for example, AP 606, NANs 614, RAN 604, hardware resources 800, and/or the like.

The UE 702 can communicatively couple with the NAN 704 via connection 706. The connection 506 is an air interface to enable communicative coupling, and can be consistent with cellular communications protocols (e.g., LTE, 5G/NR, mmWave or sub-6 GHZ frequencies, and/or any other access network protocol). The connection 506 may correspond to the Uu interface described w.r.t FIG. 6.

The UE 702 includes a host platform 708 coupled with a modem platform 710. The host platform 708 includes application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations includes transport (e.g., user datagram protocol (UDP), QUIC (Quick UDP Internet Connections), transmission control protocol (TCP), GPRS Tunneling (GTP), and/or some other transport layer protocol) operations and network/Internet (e.g., internet protocol (IP), IPSec, routing information protocol (RIP), external gateway protocol (EGP), internet control message protocol (ICMP), internet group management protocol (IGMP), and/or some other network and/or Internet layer protocol) operations. The protocol processing circuitry 714 may perform one or more protocol layer operations to facilitate transmission or reception of data over the connection 706. The protocol layer operations implemented by the protocol processing circuitry 714 includes, for example, operations for some or all of the following layers: physical layer (PHY), medium access control (MAC), radio link control layer (RLC), packet data convergence protocol (PDCP), service data adaptation protocol (SDAP), radio resource control (RRC), and/or non-access stratum (NAS).

The PHY layer includes capabilities, for example, to transmit and receive modulated signals for communicating in a communications network as discussed in 3GPP TS 38.201 and 3GPP TS 36.201. The MAC layer governs access to the transmission medium in a network, to enable the exchange of data between stations in a network; performs functions to provide frame-based, connectionless-mode (e.g., datagram style) data transfer between stations or devices; and/or performs, inter alia, mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding as discussed in 3GPP TS 38.321 (“[TS38321]”), 3GPP TS 36.321, and/or IEEE 802.11. The RLC layer performs, inter alia, transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection as discussed in 3GPP TS 38.322 and/or 3GPP TS 36.322).

The PDCP layer performs, inter alia, transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery as discussed in 3GPP TS 36.323 and/or 3GPP TS 38.323. The SDAP layer performs, inter alia, mapping between QoS flows and a data radio bearers (DRBs) and marking QoS flow IDs (QFI) in both DL and UL packets as discussed in 3GPP TS 37.324.

The RRC layer performs, inter alia, system information handling; paging; establishment, maintenance, and release of RRC connections; security functions; establishment, configuration, maintenance and release of Signaling Radio Bearers (SRBs) and Data Radio Bearers (DRBs); mobility functions/services; QoS management; and some sidelink specific services and functions over the Uu interface as discussed in 3GPP TS 36.331 and/or [TS38331]. The NAS layer forms the highest stratum of the control plane between UE 702 and AMF 644 (e.g., reference point “N1” as shown by FIG. 6 and as described in [TS23501]) for both 3GPP and non-3GPP access, supports mobility of the UE 702 (e.g., including common procedures, such as authentication, identification, generic UE configuration update and security mode control procedures), supports session management procedures to establish and maintain data connectivity between the UE 702 and the DN 636, and/or NAS transport procedure to provide a transport of short message service (SMS), LTE positioning protocol (LPP), location services (LCS), UE policy container, steering of roaming (SOR) transparent container, and UE parameters update information payload as discussed in 3GPP TS 24.301 and/or 3GPP TS 24.501.

The modem platform 710 may further include digital baseband circuitry 716 that may implement one or more layer operations that are “below” layer operations performed by the protocol processing circuitry 714 in a network protocol stack. These operations includes, for example, PHY operations including one or more of HARQ functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and/or other related functions, including any of those discussed herein and/or in 3GPP TS 36.201, 3GPP TS 38.201, [TS38211], [TS38212], [TS38213], [TS38214], and/or any other standards/specifications, including any of those mentioned herein. In some examples, the protocol processing circuitry 714 includes one or more instances of control circuitry (not shown) to provide control functions for the transmit/receive components.

The modem platform 710 may further include transmit circuitry 718, receive circuitry 720, RF circuitry 722, and RF front end (RFFE) 724, which includes or connect to one or more antenna panels 726. Briefly, the transmit circuitry 718 includes a digital-to-analog converter, mixer, intermediate frequency (IF) components, and/or the like; the receive circuitry 720 includes an analog-to-digital converter, mixer, IF components, and/or the like; the RF circuitry 722 includes a low-noise amplifier, a power amplifier, power tracking components, and/or the like; RFFE 724 includes filters (e.g., surface/bulk acoustic wave filters), switches, antenna tuners, beamforming components (e.g., phase-array antenna components), and/or the like The selection and arrangement of the components of the transmit circuitry 718, receive circuitry 720, RF circuitry 722, RFFE 724, and antenna panels 726 (referred generically as “transmit/receive components” or “Tx/Rx components”) may be specific to details of a specific implementation such as, for example, whether communication is TDM or FDM, in mmWave or sub-6 gHz frequencies, and/or the like. In some examples, the transmit/receive components may be arranged in multiple parallel Tx/Rx chains, may be disposed in the same or different chips/modules, and/or the like.

A UE reception may be established by and via the antenna panels 726, RFFE 724, RF circuitry 722, receive circuitry 720, digital baseband circuitry 716, and protocol processing circuitry 714. In some examples, the antenna panels 726 may receive a transmission from the NAN 704 by receive-beamforming signals received by a set of antennas/antenna elements of the one or more antenna panels 726. A UE transmission may be established by and via the protocol processing circuitry 714, digital baseband circuitry 716, transmit circuitry 718, RF circuitry 722, RFFE 724, and antenna panels 726. In some examples, the transmit components of the UE 704 may apply a spatial filter to the data to be transmitted to form a transmit beam emitted by the antenna elements of the antenna panels 726.

Similar to the UE 702, the NAN 704 includes a host platform 728 coupled with a modem platform 730. The host platform 728 includes application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the NAN 704 may be similar to and substantially interchangeable with like-named components of the UE 702. In addition to performing data transmission/reception as described above, the components of the NAN 704 may perform various logical functions that include, for example, RNC functions such as radio bearer management, UL and DL dynamic radio resource management, and data packet scheduling. Examples of the antenna elements of the antenna panels 726 and/or the antenna elements of the antenna panels 746 include planar inverted-F antennas (PIFAs), monopole antennas, dipole antennas, loop antennas, patch antennas, Yagi antennas, parabolic dish antennas, omni-directional antennas, and/or the like.

FIG. 8 illustrates components capable of reading instructions from a machine-readable or computer-readable medium (e.g., a non-transitory machine-readable storage medium) and perform any one or more of the methodologies discussed herein. Specifically, FIG. 8 shows hardware resources 800 including one or more processors (or processor cores) 810, one or more memory/storage devices 820, and one or more communication resources 830, each of which may be communicatively coupled via a bus 840 or other interface circuitry. For examples where node virtualization (e.g., NFV) is utilized, a hypervisor 802 may be executed to provide an execution environment for one or more network slices/sub-slices to utilize the hardware resources 800. In some examples, the hardware resources 800 may be implemented in or by an individual compute node, which may be housed in an enclosure of various form factors. In other examples, the hardware resources 800 may be implemented by multiple compute nodes that may be deployed in one or more data centers and/or distributed across one or more geographic regions.

The processors 810 may include processors (or cores) 810-1 to 810-p (where p is a number). Individual processors 810-1 to 810-p may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof. Each processor (or core) 810-1 to 810-p may be the same as, or different from, each other processor (or core) 810-1 to 810-p.

The memory/storage devices 820 may include main memory, disk storage, or any suitable combination thereof. The memory/storage devices 820 may include, but are not limited to, any type of volatile, non-volatile, semi-volatile memory, and/or any combination thereof. As examples, the memory/storage devices 620 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, and/or a combination of any of the aforementioned memory devices, and/or other memory.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, and/or the like), cellular communication components, NFC components, Bluetooth® components, WiFi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's 810 cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

In some examples, the peripheral devices 804 may represent one or more sensors such as, for example, exteroceptive sensors, proprioceptive sensors, and/or exproprioceptive sensors (e.g., sensors that capture, measure, or correlate internal states and external states). Examples of such sensors include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors/thermistors; pressure sensors; barometric pressure sensors; gravimeters; altimeters; image sensors/cameras; light detection and ranging (LiDAR) sensors; proximity sensors; depth sensors, ambient light sensors; optical light sensors; ultrasonic transceivers; microphones; power, energy, environmental (PEE) sensor(s); gas sensors; and the like.

Additionally or alternatively, the peripheral devices 604 may represent one or more actuators such as, for example, soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors (e.g., those discussed previously), clutches, and the like), projectile actuators/mechanisms (e.g., mechanisms that shoot or propel objects or elements), and/or audible sound generators, visual warning devices, and/or other like electromechanical components.

### 3. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.
Example 1 includes a method for performing mobile terminated small data transmission (MT-SDT) in a network, comprising: paging a user equipment (UE) with an MT-SDT indication; and the UE initiating a resume procedure based on the MT-SDT indication.
Example 2 includes the method of example 1 and/or some other example(s) herein, wherein the method includes: configuring radio bearers (RBs) configured for MT-SDT (MT-SDT RB) via suspendConfig included RRCRelease message.
Example 3 includes the method of example 2 and/or some other example(s) herein, wherein the configuration for MT-SDT of can indicate the actual RBs to use during MT-SDT, which may be a sub-set of the RBs also configured for mobile originated SDT (MO-SDT RBs), or an indication on whether MT-SDT is allowed in the MO-SDT RBs.
Example 4 includes the method of examples 1-3 and/or some other example(s) herein, wherein the method includes: resuming any RBs configured for SDT (including both MO-SDT RBs and MT-SDT RBs) when resume is initiated due to MT-SDT indicating.
Example 5 includes the method of examples 1-4 and/or some other example(s) herein, wherein the method includes: resuming only RBs configured for MT-SDT (MT-SDT RBs) when resume is initiated due to MT-SDT indicating.
Example 6 includes the method of example 5 and/or some other example(s) herein, wherein the method includes: when only MT-SDT RBs are resumed, performing a fallback mechanism to resume only remaining MO-SDT RBs if SDT is detected is detected on those MO-SDT RBs that were still suspended.
Example 7 includes the method of examples 1-6 and/or some other example(s) herein, wherein the method includes: falling back to normal resume in which UE AS layer set resume case value to MT-Access even when UE initiated resume due to a MT-SDT indication.
Example 8 includes the method of examples 1-7 and/or some other example(s) herein, wherein the method includes: colliding with UL data being available in UE side.
Example 9 includes the method of example 8 and/or some other example(s) herein, wherein, when UL data and MT-SDT indication are both detected in UE side, UE behavior can be specified.
Example 10 includes the method of example 9 and/or some other example(s) herein, wherein, when UL data is non-SDT, the UE can initiate legacy resume while including MT-SDT resume cause, or when UL data is SDT, UE can initiate MO-SDT while including MT-SDT resume cause.
Example 11 includes the method of examples 1-10 and/or some other example(s) herein, wherein the UE provide support MT-SDT feature as standalone or dependent to Rel-17 SDT features.
Example 12 includes the method of examples 1-11 and/or some other example(s) herein, wherein the method is performed by a UE or a network access node.
Example 13 includes a method of operating a radio resource control (RRC) layer, the method comprising: determining that a mobile terminated small data transmission (MT-SDT) indication for the UE is included in a received paging message; and initiating an RRC resume procedure with a resume cause value in an RRC resume request message set to “mt-SDT” when an the MT-SDT indication for the UE is included in the received paging message and when a set of conditions for initiating MT-SDT have been fulfilled.
Example 14 includes the method of example 13 and/or some other example(s) herein, wherein the method includes: causing the RRC layer to obtain, from a lower layer entity, an indication that the set of conditions for initiating MT-SDT have been fulfilled.
Example 15 includes the method of example 14 and/or some other example(s) herein, wherein the lower layer entity is a medium access control (MAC) entity.
Example 16 includes the method of examples 13-15 and/or some other example(s) herein, wherein the set of conditions for initiating MT-SDT have been fulfilled includes a reference signal received power (RSRP) of a downlink pathloss reference being higher than a configured RSRP threshold.
Example 17 includes the method of examples 13-16 and/or some other example(s) herein, wherein the set of conditions for initiating MT-SDT have been fulfilled includes an RSRP threshold not being configured.
Example 18 includes the method of examples 13-17 and/or some other example(s) herein, wherein the method includes: initiating the RRC resume procedure with a resume cause value of “mt-Access” in the RRC resume request message when the set of conditions for initiating MT-SDT have not been fulfilled.
Example 19 includes the method of examples 13-18 and/or some other example(s) herein, wherein the paging message includes a paging record information element (IE), and the method includes: determining whether the MT-SDT indication is included in the paging message when a UE identity included in the paging record IE matches a stored full inactive radio network temporary identifier (I-RNTI).
Example 20 includes the method of examples 13-19 and/or some other example(s) herein, wherein the method includes: determining one or more radio bearers (RBs) configured for SDT over which to transmit the RRC resume request.
Example 21 includes the method of examples 13-20 and/or some other example(s) herein, wherein the method includes: receiving the paging message from a radio access network (RAN) node; and transmitting the RRC resume request message to the RAN node.
Example 22 includes the method of examples 13-21 and/or some other example(s) herein, wherein the method is performed by a user equipment (UE).
Example 23 includes the method of example 22 and/or some other example(s) herein, wherein the UE is in an RRC_INACTIVE state when the paging message is received.
Example 24 includes one or more computer readable media comprising instructions, wherein execution of the instructions by processor circuitry is to cause the processor circuitry to perform the method of any one of examples 1-23. Example 25 includes a computer program comprising the instructions of example 24. Example 26 includes an Application Programming Interface defining functions, methods, variables, data structures, and/or protocols for the computer program of example 25. Example 27 includes an API or specification defining functions, methods, variables, data structures, protocols, and the like, defining or involving use of any of examples 1-23 or portions thereof, or otherwise related to any of examples 1-23 or portions thereof. Example 28 includes an apparatus comprising circuitry loaded with the instructions of example 24. Example 29 includes an apparatus comprising circuitry operable to run the instructions of example 24. Example 30 includes an integrated circuit comprising one or more of the processor circuitry of example 24 and the one or more computer readable media of example 24. Example 31 includes a computing system comprising the one or more computer readable media and the processor circuitry of example 24. Example 32 includes an apparatus comprising means for executing the instructions of example 24. Example 33 includes a signal generated as a result of executing the instructions of example 24. Example 34 includes a data unit generated as a result of executing the instructions of example 24. Example 35 includes the data unit of example Z10 and/or some other example(s) herein, wherein the data unit is a datagram, network packet, data frame, data segment, a Protocol Data Unit (PDU), a Service Data Unit (SDU), a message, or a database object. Example 36 includes a signal encoded with the data unit of examples 34-35. Example 37 includes an electromagnetic signal carrying the instructions of example 24. Example 38 includes an apparatus comprising means for performing the method of any one of examples 1-23 and/or some other example(s) herein. Example 39 includes a compute node executing a service as part of one or more applications instantiated on virtualization infrastructure, the service being related to any of examples 1-23, portions thereof, and/or some other example(s) herein.

### 4. Terminology

For the purposes of the present document, the terms and definitions mentioned in '192 and [TS38331], as well as the following terms and definitions are applicable to the examples and embodiments discussed herein.

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The term “element” at least in some examples refers to a unit that is indivisible at a given level of abstraction and has a clearly defined boundary, wherein an element may be any type of entity including, for example, one or more devices, systems, controllers, network elements, modules, engines, components, and so forth, or combinations thereof. The term “entity” at least in some examples refers to a distinct element of a component, architecture, platform, device, and/or system. Additionally or alternatively, the term “entity” at least in some examples refers to information transferred as a payload.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “device” at least in some examples refers to a physical entity embedded inside, or attached to, another physical entity in its vicinity, with capabilities to convey digital information from or to that physical entity.

The term “controller” at least in some examples refers to an element or entity that has the capability to affect a physical entity, such as by changing its state or causing the physical entity to move.

The term “scheduler” at least in some examples refers to an entity or element that creates or generates a list of times, sequence(s), and/or an order in which tasks, events, actions, jobs, and/or the like are intended to take place. Additionally or alternatively, the term “scheduler” at least in some examples refers to an entity or element that schedules, coordinates, and/or manages tasks, events, actions, jobs, and/or the like to run or execute at specific times, under certain conditions or parameters, and/or based on (pre)defined or configured priorities. Additionally or alternatively, the term “scheduler” at least in some examples refers to an entity or element that assigns or otherwise manages resources and/or timings to perform tasks, events, actions, jobs, and/or the like. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like.

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” includes specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (cNB) or a next generation Node B (gNB)), an access point and/or wireless network access point, router, switch, hub, radio unit or remote radio head, Transmission Reception Point (TRP), a gateway device (e.g., Residential Gateway, Wireline 5G Access Network, Wireline 5G Cable Access Network, Wireline BBF Access Network, and the like), network appliance, and/or some other network access hardware.

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN.

The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies include any of those mentioned in '192.

The terms “configuration”, “policy”, “ruleset”, and/or “operational parameters”, at least in some examples refer to a machine-readable information object that contains instructions, conditions, parameters, and/or criteria that are relevant to a device, system, or other element/entity.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information.

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like).

The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

The term “small data transmission” or “SDT” at least in some examples refers to a procedure used for transmission of data and/or signaling over allowed radio bearers in an RRC_INACTIVE state (e.g., without a UE transitioning to an RRC_CONNECTED state). The term “mobile originated SDT” or “MO-SDT” at least in some examples refers to an SDT originating from a UE. The term “mobile terminated SDT” or “MT-SDT” at least in some examples refers to an SDT originating from a network element. The term “small data” at least in some examples refers to a data payload included in an SDT. In some examples, “small data” can include a data payload and/or control signaling.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like.

However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. An apparatus to be implemented in a user equipment (UE), the apparatus comprising:
memory circuitry to store a received paging message; and
processor circuitry connected to the memory circuitry, wherein the processor circuitry is to initiate a radio resource control (RRC) resume procedure with a resume cause value of “mt-SDT” in an RRC resume request when:
a mobile terminated small data transmission (MT-SDT) indication for the UE is included in the received paging message, and
a set of conditions for initiating MT-SDT have been fulfilled.

2. The apparatus of claim 1, wherein the processor circuitry is to:
obtain, from a lower layer entity, an indication that the set of conditions for initiating MT-SDT have been fulfilled.

3. The apparatus of claim 2, wherein the lower layer entity is a medium access control (MAC) entity.

4. The apparatus of claim 1, wherein the set of conditions for initiating MT-SDT have been fulfilled includes a reference signal received power (RSRP) of a downlink pathloss reference being higher than a configured RSRP threshold.

5. The apparatus of claim 1, wherein the set of conditions for initiating MT-SDT have been fulfilled includes an RSRP threshold not being configured.

6. The apparatus of claim 1, wherein the processor circuitry is to:
initiate the RRC resume procedure with a resume cause value of “mt-Access” in the RRC resume request message when the set of conditions for initiating MT-SDT have not been fulfilled.

7. The apparatus of claim 1, wherein the paging message includes a paging record information element (IE), and the processor circuitry is to:
determine whether the MT-SDT indication is included in the paging message when a UE identity included in the paging record IE matches a full inactive radio network temporary identifier (I-RNTI) stored in the memory circuitry.

8. The apparatus of claim 1, wherein the UE is in an RRC_INACTIVE state when the paging message is received.

9. The apparatus of claim 1, wherein the processor circuitry is to:
determine one or more radio bearers (RBs) configured for SDT over which to transmit the RRC resume request.

10. The apparatus of claim 1, further comprising:
radiofrequency (RF) circuitry connected to the processor circuitry, wherein the RF circuitry is to:
receive the paging message from a radio access network (RAN) node; and
transmit the RRC resume request message to the RAN node.

11. A non-transitory computer readable media (NTCRM) comprising instructions for operating a radio resource control (RRC) layer, wherein execution of the instructions by one or more processors of a user equipment (UE) is to cause the UE to:
determine that a mobile terminated small data transmission (MT-SDT) indication for the UE is included in a received paging message; and
initiate an RRC resume procedure with a resume cause value in an RRC resume request message set to “mt-SDT” when an the MT-SDT indication for the UE is included in the received paging message and when a set of conditions for initiating MT-SDT have been fulfilled.

12. The NTCRM of claim 11, wherein execution of the instructions is to cause the UE to:
cause the RRC layer to obtain, from a lower layer entity, an indication that the set of conditions for initiating MT-SDT have been fulfilled.

13. The NTCRM of claim 12, wherein the lower layer entity is a medium access control (MAC) entity.

14. The NTCRM of claim 11, wherein the set of conditions for initiating MT-SDT have been fulfilled includes a reference signal received power (RSRP) of a downlink pathloss reference being higher than a configured RSRP threshold.

15. The NTCRM of claim 11, wherein the set of conditions for initiating MT-SDT have been fulfilled includes an RSRP threshold not being configured.

16. The NTCRM of claim 11, wherein execution of the instructions is to cause the UE to:
initiate the RRC resume procedure with a resume cause value of “mt-Access” in the RRC resume request message when the set of conditions for initiating MT-SDT have not been fulfilled.

17. The NTCRM of claim 11, wherein the paging message includes a paging record information element (IE), and execution of the instructions is to cause the UE to:
determine whether the MT-SDT indication is included in the paging message when a UE identity included in the paging record IE matches a stored full inactive radio network temporary identifier (I-RNTI).

18. The NTCRM of claim 11, wherein the UE is in an RRC_INACTIVE state when the paging message is received.

19. The NTCRM of claim 11, wherein execution of the instructions is to cause the UE to:
determine one or more radio bearers (RBs) configured for SDT over which to transmit the RRC resume request.

20. The NTCRM of claim 11, wherein execution of the instructions is to cause the UE to:
receive the paging message from a radio access network (RAN) node; and
cause transmission of the RRC resume request message to the RAN node.
